(19) United States
(12) Patent Application Publication
(10) Pub. No.: US 2026/0289115 A1
(43) Pub. Date: Sep. 24, 2026

(54) SYSTEM

(71) Applicant: SoftBank Group Corp., Tokyo (JP)

(72) Inventor: Koji ANTO, Tokyo (JP)

(73) Assignee: SoftBank Group Corp., Tokyo (JP)

(21) Appl. No.: 19/567,002

(22) Filed: Mar. 14, 2026

(30) Foreign Application Priority Data
Mar. 19, 2025 (JP) 2025-045091

(51) Int. Cl. G06F 40/268; G06F 18/243; G06F 40/284; G06F 40/30; G06N 3/0475

(52) U.S. Cl. CPC G06F 40/268; G06F 18/243; G06F 40/284; G06F 40/30; G06N 3/0475

(57) ABSTRACT

A system includes a processor that is configured to prepare identification information of an information collection target, acquire information via a communication network based on the identification information, analyze and classify the acquired information, store the classified information in a storage device, generate, on the basis of the information stored in the storage device, a prompt sentence for instructing generation of a solution to be input to a generative AI model, input the prompt sentence into the generative AI model and generate a solution in response to an individual request, and provide the generated solution to a user.

### CROSS-REFERENCE TO RELATED APPLICATION

This application is based on and claims priority under 35 USC 119 from Japanese Patent Application No. 2025-045091 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for supporting educational tasks and stakeholder communications largely rely on manually curated data and static templates. In such systems, a human operator typically searches scattered information sources, filters relevant content, and drafts learning assignments, evaluation tests, or responses to guardians by hand. This manual workflow is time-consuming, requires significant expertise, and is difficult to scale across different subjects, grade levels, and case types. Furthermore, even when generative AI models are introduced, they are often used in an ad hoc manner without systematic integration with curated educational data, resulting in inconsistent quality of proposed solutions and a lack of traceability to underlying information sources. Accordingly, there is a need for a system that can automatically collect, classify, and structure diverse information via a communication network, and that can reliably generate high-quality, context-appropriate solutions by supplying a generative AI model with prompts constructed on the basis of the classified and stored information. There is also a need to flexibly handle different categories of educational tasks, including creation of learning assignments and evaluation tests, and generation of response measures to guardians, while reducing the workload on educators and staff and improving the consistency and relevance of the generated solutions.

### SUMMARY

In order to solve the foregoing problems, according to one aspect of the present invention, there is provided a system comprising a processor, wherein the processor is configured to prepare identification information of an information collection target and to acquire information via a communication network based on the identification information. The processor is further configured to analyze and classify the acquired information and to store the classified information in a storage device. The processor is configured to generate, on the basis of the information stored in the storage device, a prompt sentence for instructing generation of a solution to be input to a generative AI model, to input the prompt sentence into the generative AI model, to generate a solution in response to an individual request, and to provide the generated solution to a user. In one embodiment, the processor is configured to analyze a prompt sentence for instructing generation of a solution relating to creation of learning assignments and creation of evaluation tests, and to generate the solution using data related to the creation of learning assignments and the creation of evaluation tests stored in the storage device. In another embodiment, the processor is configured to analyze a prompt sentence for instructing generation of a solution relating to responses to guardians, and to generate, based on needs of the guardians, a response measure as the solution. By integrating automated information collection, structured storage, and prompt-based interaction with a generative AI model within a single system, the invention enables efficient and scalable generation of context-appropriate solutions for various educational scenarios.

The term “system” refers to an integrated combination of hardware and software components, including at least one processor and one or more storage devices, configured to execute the processing described in the claims of the present invention.

The term “processor” refers to one or more hardware processing units, such as a central processing unit (CPU), graphics processing unit (GPU), or specialized accelerator, that execute instructions to perform the functions and operations specified in the present specification and claims.

The term “information collection target” refers to a source or set of sources from which information is to be obtained via a communication network, such as websites, databases, online services, or other network-accessible repositories.

The term “identification information of an information collection target” refers to data that uniquely or specifically identifies an information collection target, including, for example, a URL, an API endpoint, an IP address, a resource identifier, or other addressing or referencing information.

The term “communication network” refers to any wired or wireless network through which data can be transmitted between the system and external information sources, including, for example, the Internet, local area networks (LANs), wide area networks (WANs), or cellular networks.

The term “acquire information” refers to the act of obtaining data from an information collection target via the communication network, including, for example, by issuing network requests, receiving responses, downloading files, or calling external APIs.

The term “analyze” refers to processing acquired information to extract structure, meaning, features, or patterns, including operations such as parsing, tokenizing, performing natural language processing, identifying entities, or extracting key attributes.

The term “classify” refers to assigning one or more categories, labels, or attributes to the acquired information based on its content or characteristics, such as subject, grade, topic, type of case, or other classification criteria.

The term “classified information” refers to information that has been assigned one or more categories, labels, or attributes through a classification process, and that is therefore organized or structured according to such categories or labels.

The term “storage device” refers to any non-transitory physical medium capable of storing data, including, for example, magnetic disks, solid-state drives, optical disks, flash memory, or other forms of memory used to store classified information and associated metadata.

The term “prompt sentence” refers to a text or structured instruction that is provided as input to a generative AI model to direct or constrain the model's generation of a solution, and that may include problem descriptions, conditions, examples, or other contextual information.

The term “solution” refers to output generated in response to an individual request, based at least in part on the classified information and the prompt sentence, and may include, for example, proposals, recommendations, draft documents, assignments, or response measures.

The term “generative AI model” refers to an artificial intelligence model, such as a large language model or other generative model, that generates text or other content in response to input data including a prompt sentence.

The term “individual request” refers to a request issued by or on behalf of a user specifying a particular problem, condition, or use case for which the system is to generate a corresponding solution.

The term “user” refers to a human operator or entity that interacts with the system, issues individual requests, receives generated solutions, and may review, modify, or use the generated solutions.

The term “learning assignments” refers to educational tasks, exercises, homework, or practice problems to be given to learners for the purpose of learning or practicing specific knowledge or skills.

The term “evaluation tests” refers to tests, exams, quizzes, or other assessment instruments designed to measure learners' understanding, performance, or proficiency in specific subjects or topics.

The term “data related to the creation of learning assignments and the creation of evaluation tests” refers to information stored in the storage device that is relevant for generating learning assignments or evaluation tests, including, for example, example questions, answer keys, rubrics, curriculum standards, or historical assignment and test data.

The term “guardians” refers to parents, legal guardians, or other persons responsible for the care and oversight of learners, with whom educational institutions may need to communicate or coordinate.

The term “responses to guardians” refers to communications, replies, or response measures addressed to guardians, including, for example, explanations, notifications, proposals, or solutions to concerns raised by the guardians.

The term “response measure” refers to a proposed approach, plan, or content of communication generated by the system as a solution to address issues, requests, complaints, or needs expressed by guardians.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

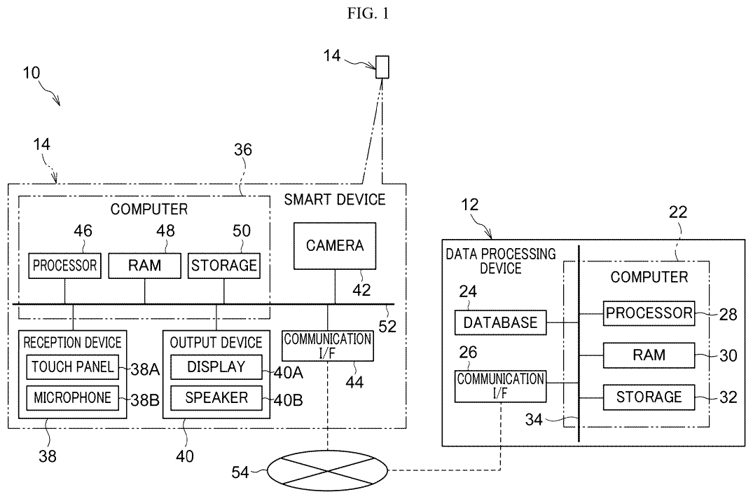

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

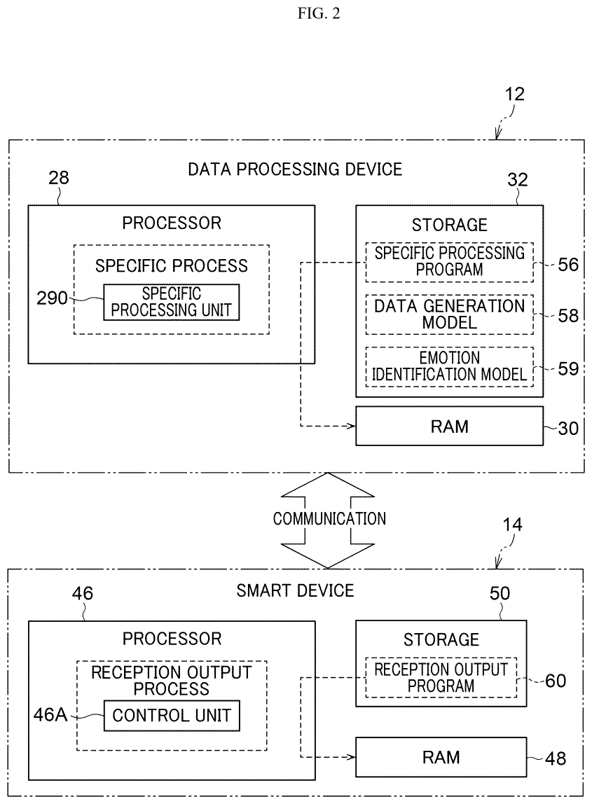

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented educational support systems generally rely on manually curated content or simple keyword-based retrieval from static databases. These systems typically store pre-authored teaching materials or guidelines and, upon receiving a query from a user, execute straightforward string matching or rule-based selection. As a result, several technical problems arise in terms of information acquisition, data organization, and response generation.

First, on the information acquisition side, existing systems do not efficiently harvest large-scale, heterogeneous educational information distributed over networked resources. Web content is often stored as unstructured markup documents containing presentation tags, navigation fragments, advertisements, and other noise. Traditional crawlers and scrapers may download such documents, but they do not perform robust, automated extraction of educational body text, nor do they normalize and preprocess the text in a machine-understandable manner. Consequently, the underlying data store becomes either sparse or noisy, which degrades the performance of downstream retrieval and processing modules executed by a computer.

Second, on the data organization side, conventional systems generally do not perform fine-grained classification and indexing of educational information that are aligned with actual educational use cases such as learning-task creation, evaluation-test creation, and guardian correspondence. Existing architectures often apply simple tag assignment or folder-based grouping and maintain only basic keyword indexes. Such limited structuring prevents the processor from quickly locating contextually relevant information across large collections when a user submits a complex, natural-language query. This leads to high latency and low retrieval precision from the perspective of computer system performance. Third, on the response generation side, some recent systems have introduced generative models, but they typically invoke such models directly on the user's prompt without integrating structured contextual information derived from a curated educational corpus. In many implementations, the generative model is treated as a black box that receives only the prompt sentence from the user terminal. Without an intermediate step of selecting and formatting relevant educational records as context information, the generative model may produce generic or hallucinated answers, and the computing resources of the model are not efficiently leveraged. Furthermore, existing systems rarely implement a unified pipeline that harmonizes web-scale data collection, database indexing, semantic search, and context-aware invocation of a generative model under consistent preprocessing and analysis procedures executed by the processor.

Thus, there is a need for computer technology that improves the entire processing pipeline, from automatic collection and normalization of educational web content, through category-specific structuring and hybrid (full-text and semantic) indexing, to context-augmented invocation of a generative AI model. In particular, it is desirable to provide a server-side architecture and processing method that (i) automatically identifies and acquires education-related electronic documents from distributed network resources, (ii) converts those documents into structured education-related information records with category and index data suitable for high-performance search, and (iii) dynamically constructs, in response to a prompt sentence, optimized model input data including both the prompt sentence and selected context information, thereby improving the quality, relevance, and computational efficiency of solutions generated by a generative AI model.

The specific processing by the specific processing unit 290 of the data processing device 12 in Example 1 is realized by the following means.

The present invention provides a server comprising a processor configured to generate identification information for information-collection targets and, based on the identification information, create a list of information-collection targets including location information of education-related information sources; obtain, by using the location information included in the list of information-collection targets, education-related document information from an external information processing apparatus via a communication network, and record the obtained document information as unstructured electronic documents; analyze the obtained electronic documents by using an analysis program, remove display-related structure information, extract education-related body text, and generate analysis-target text data by performing preprocessing including character-string normalization and morphological analysis or word segmentation; apply, to the analysis-target text data, topic estimation and relevance calculation by using vocabulary information related to an education field or a learning model, and generate education-related information records classified for each education category including at least a learning-task-creation category, an evaluation-test-creation category, and a guardian-correspondence category; register the education-related information records, as structured data including category information, summary information, location information, and search index information, in a data storage apparatus including a relational data management apparatus or a similar data storage apparatus, and generate data structures for full-text search indexes or vector search indexes; receive, from a user terminal, a prompt sentence related to an educational task, preprocess the prompt sentence by natural language processing, execute full-text search and semantic-similarity search on the data storage apparatus, extract education-related information records related to the prompt sentence, and generate context information by summarizing or formatting extraction results; generate input data including the prompt sentence and the context information, format the input data as model input data to be input to a generative AI model, operate the generative AI model to generate an education-related solution in accordance with an individual request, and perform content checking or format adjustment on the solution output from the generative AI model, generate presentation data for providing the solution to the user terminal, and transmit the presentation data to the user terminal via the communication network. This enables an integrated, computer-implemented pipeline in which the server automatically acquires and normalizes web-based educational content, structures and indexes that content in a manner optimized for hybrid full-text and semantic search, and dynamically constructs context-augmented model input data for a generative AI model, thereby improving the technical performance of information retrieval and response generation, reducing processing latency, and enhancing the relevance and reliability of solutions produced for education-related prompt sentences.

The term “information-collection target” refers to a logical unit of an external information source, such as a network-accessible resource or content location, from which education-related electronic documents are to be acquired by the server.

The term “identification information for information-collection targets” refers to data used by the server to uniquely or specifically designate information-collection targets, including, for example, resource locators, identifiers, or query parameters that indicate where and what kind of educational information is to be collected.

The term “location information of education-related information sources” refers to data indicating the network location or access path of an education-related information source, such as a uniform resource locator, network address, or endpoint specification that enables retrieval of electronic documents via a communication network.

The term “education-related document information” refers to electronic content that includes textual or mixed-media information associated with educational activities, such as descriptions of learning tasks, evaluation tests, lesson plans, or communication cases with guardians.

The term “unstructured electronic documents” refers to electronic files or data streams containing content encoded with markup or formatting information, without having been converted into a predefined schema of fields, attributes, or database records.

The term “analysis program” refers to one or more software modules executed by the processor that perform parsing, structural analysis, text extraction, and linguistic processing on electronic documents.

The term “display-related structure information” refers to markup elements, formatting tags, scripts, navigation components, advertisements, and other structural data used primarily for presentation or layout of content, which are not required for semantic analysis of educational body text.

The term “education-related body text” refers to portions of textual content within an electronic document that express substantive educational information, excluding headers, footers, navigation text, and other non-content elements.

The term “analysis-target text data” refers to textual data generated from electronic documents after removal of display-related structure information and application of preprocessing operations, and that is used as input for subsequent topic estimation, classification, and indexing.

The term “character-string normalization” refers to processing that converts raw text into a canonical form, including, for example, unifying character encodings, normalizing whitespace, converting variant character forms, and removing or converting control symbols, to facilitate consistent analysis.

The term “morphological analysis” refers to linguistic processing that segments text into morphemes or word units and assigns grammatical or lexical attributes to each segment.

The term “word segmentation” refers to processing that separates a continuous character sequence into individual word units according to language-specific rules, without necessarily assigning grammatical categories.

The term “vocabulary information related to an education field” refers to a collection of words, phrases, or terminology and associated metadata that are specific to educational domains, such as subject names, pedagogical concepts, assessment terms, and guardian-communication expressions.

The term “learning model” refers to a computational model, including but not limited to a statistical model, a machine-learning model, or a neural-network model, that is trained to analyze or classify text or to estimate topics and relevance values.

The term “topic estimation” refers to a process in which the processor infers one or more topical categories or themes for a given text based on vocabulary information, statistical patterns, or outputs of a learning model.

The term “relevance calculation” refers to computation of a score indicating the degree of association or importance between a text segment and one or more predefined categories, topics, or query conditions.

The term “education-related information record” refers to a structured data entry stored in a data storage apparatus, which represents a unit of educational content and includes at least category information, textual content, and metadata.

The term “education category” refers to a logical classification label used to group education-related information records according to their educational function or use case, such as learning-task creation, evaluation-test creation, or guardian correspondence.

The term “learning-task-creation category” refers to an education category that encompasses information related to the design, preparation, or adjustment of assignments, exercises, or homework for learners.

The term “evaluation-test-creation category” refers to an education category that encompasses information related to the design, preparation, or adjustment of tests, quizzes, examinations, or other assessment instruments.

The term “guardian-correspondence category” refers to an education category that encompasses information related to communication, consultation, or coordination with guardians of learners, including example messages and response strategies.

The term “data storage apparatus” refers to a hardware and software system that stores, manages, and provides access to data, including but not limited to relational databases, key-value stores, or other persistent storage mechanisms.

The term “relational data management apparatus” refers to a data storage apparatus that manages data according to a relational model, wherein data is represented as tables with rows and columns and is accessed by a structured query language or an equivalent relational interface.

The term “structured data” refers to data that is organized according to a predefined schema with explicit fields, data types, and relationships, enabling efficient querying, indexing, and retrieval.

The term “category information” refers to data within a structured record that indicates the education category or subcategory to which the record belongs.

The term “summary information” refers to a condensed representation of an education-related information record, such as an abstract, synopsis, or key sentence set, that expresses the main content in a shorter form.

The term “search index information” refers to data structures or metadata derived from education-related information records and used to accelerate search operations, including keyword indexes, full-text indexes, or vector indexes.

The term “full-text search index” refers to an index that enables search operations over text fields in which query terms are matched against tokenized text entries, often with support for relevance scoring, ranking, or boolean operations.

The term “vector search index” refers to an index structure that stores vector representations of text or other data items and supports search based on similarity metrics between vectors.

The term “user terminal” refers to an information processing device operated by a user, such as a personal computer, a smartphone, a tablet, or another client device capable of transmitting prompt sentences and receiving solutions via a communication network.

The term “prompt sentence” refers to a natural-language input provided by a user via a user terminal, describing an educational task, requirement, or question, and used by the server as a basis for retrieving information and invoking a generative AI model.

The term “natural language processing” refers to a set of computational techniques for processing, analyzing, and understanding human language text, including tokenization, part-of-speech tagging, lemmatization, parsing, and semantic analysis.

The term “semantic-similarity search” refers to a search operation in which the system compares vector or feature representations of a query and stored text items to identify items that are similar in meaning rather than merely sharing exact keywords.

The term “context information” refers to text and metadata generated by the server from extracted education-related information records, including summaries, key sentences, and associated attributes, which are provided together with a prompt sentence to a generative AI model.

The term “input data” refers to data constructed by the server that includes at least a prompt sentence and associated context information and that is prepared for submission to a generative AI model.

The term “model input data” refers to a formatted version of the input data that conforms to an input specification of a generative AI model, including any required structure, headers, or segmentation.

The term “generative AI model” refers to an artificial intelligence model, such as a neural-network-based language model, that is configured to generate textual or other output data in response to input data including a prompt sentence and optional context information.

The term “education-related solution” refers to a generated output that includes guidance, recommendations, example tasks, response strategies, or other information addressing an educational task or problem specified by a prompt sentence.

The term “content checking” refers to post-processing of generated output to detect and handle undesired content, such as inappropriate expressions, policy-violating information, or inconsistent statements.

The term “format adjustment” refers to processing that restructures a generated output into a desired presentation format, such as paragraphs, numbered lists, bullet points, or section headings.

The term “presentation data” refers to data that includes a finalized version of an education-related solution, optionally with formatting or references, and that is suitable for direct rendering or display on a user terminal.

The term “communication network” refers to an infrastructure that enables data transmission between the server, external information processing apparatuses, and user terminals, including wired or wireless networks based on packet communication protocols.

In an embodiment, a server includes at least one processor, a main memory, a non-volatile storage device such as a solid-state drive, and a network interface card connected to a packet-based communication network. The server executes an operating system such as a general-purpose server operating system, and executes application software implemented, for example, in a programming language such as Python or another high-level language. The server cooperates with one or more storage systems implementing a relational database management system, such as a general-purpose relational database engine, and may further cooperate with a vector search engine or an extension module that supports similarity search based on vector representations.

A terminal includes a processor, a display unit, an input unit such as a keyboard or touch panel, a memory, and a communication interface. The terminal executes a web browser or a native application and communicates with the server via a secure communication protocol. A user operates the terminal to input natural-language text and to view solutions generated by the server.

The server executes a software module that generates identification information for information-collection targets. The server stores, in the database, a collection of base locations of education-related information sources, such as addresses of online forums, educational content repositories, or discussion sites. The server generates, in the memory, identification information that includes a uniform resource locator pattern, search query parameters, and metadata describing the type of expected educational content. The server writes these identification records into a table in the relational database. The server thereby converts loosely defined external resources into explicit, machine-processable information-collection targets.

The server uses a network communication module, implemented for example using a library such as an HTTP client library, to access external information processing apparatuses specified by the identification information. The server transmits HTTP requests over the communication network and receives responses that contain electronic documents encoded in markup languages such as HTML. The server stores the raw markup as unstructured electronic documents in a storage table, together with fields for source address, retrieval time, content type, and document hash values. By storing hash values, the server detects and avoids duplicate storage of identical documents, which reduces storage usage and improves subsequent retrieval performance.

The server executes an analysis program that uses a markup parser, such as a document object model parser or a library comparable to a tree-based HTML parser, to convert the unstructured electronic documents into in-memory node trees. The server traverses the node trees to remove display-related structure information, including navigation bars, advertisement sections, style definitions, and script code. The server applies heuristic rules that operate on tag names, attribute patterns, and text density metrics to distinguish body text from non-content. For example, the server measures the ratio of textual characters to markup characters in each node, and the server prefers nodes with high text density as candidates for body text. The server thus extracts education-related body text segments and concatenates these segments into normalized text strings.

The server then performs character-string normalization using string processing routines. The server converts all text to a standard character encoding such as UTF-8, normalizes full-width and half-width characters, standardizes punctuation marks, and collapses repeated whitespace. The server applies language-specific normalization, such as lowercasing in languages where case is meaningful, and performs optional stop word removal. The server stores the normalized text in an intermediate data structure in the database, with fields indicating language, original source document, and position information.

The server performs morphological analysis or word segmentation using a natural language processing toolkit, such as a morphological analyzer or a word tokenizer. The server invokes pre-trained tokenization models and part-of-speech taggers, which may be implemented using statistical models or neural networks, to segment the normalized text into tokens and assign grammatical tags. The server stores the token sequence and associated tags in a token table, where each token record contains a token identifier, surface form, lemma form, part-of-speech tag, and source text identifier. This data structure enables efficient downstream analysis in the database, such as frequency analysis, co-occurrence analysis, and topic modeling.

The server executes a topic estimation component using vocabulary information related to an education field and a learning model. In one embodiment, the server loads a domain-specific vocabulary list stored in a configuration table, including terms for learning tasks, evaluation tests, grading, classroom management, and guardian communication. The server computes term frequency-inverse document frequency (TF-IDF) vectors for each text segment using the token table. The server inputs the TF-IDF vectors into a classifier model implemented by a machine-learning library, such as a linear classifier, a gradient boosting model, or a neural network. In another embodiment, the server computes contextual embeddings for each segment using a transformer-based encoder network, for example a multi-layer transformer model with self-attention layers, layer normalization, and feed-forward sublayers. The server configures the transformer with hyperparameters such as number of layers, hidden dimension size, number of attention heads, and activation functions.

The server trains the learning model offline using a labeled training set of educational text segments. The server defines an objective function such as cross-entropy loss over category labels, and updates model parameters with an optimization algorithm such as stochastic gradient descent or adaptive gradient methods. The server performs backpropagation through the network layers, computes gradients for weights and biases, and updates these parameters according to the optimization rule. The server may employ regularization techniques such as dropout, weight decay, and data augmentation (for example, synonym replacement or paraphrasing of training sentences) to improve generalization. By training the model in this manner, the server obtains a parameterized function that maps token sequences or embeddings to education categories and relevance scores.

At runtime, the server inputs each analysis-target text data segment into the trained learning model. The server computes, for each predefined education category such as a learning-task-creation category, an evaluation-test-creation category, and a guardian-correspondence category, a probability score representing the relevance of the text to that category. The server assigns to each segment one or more category labels according to a rule-based decision function, for example selecting all categories whose probability exceeds a threshold, or selecting the category with maximum probability. The server also outputs a numeric relevance value that is stored in a field of the education-related information record. The server constructs an education-related information record as a structured data object. The server includes fields such as record identifier, category information, subcategory information, main text, summary information, source location, retrieval time, and relevance scores. In one embodiment, the server generates summary information by applying an extractive summarization algorithm, which selects representative sentences based on sentence centrality in an embedding space or based on term coverage. The server inserts each structured record into a relational table and maintains referential integrity constraints between tables storing documents, tokens, and records.

The server generates search index information for fast retrieval. For full-text search, the server tokenizes the main text field and builds an inverted index mapping terms to record identifiers. The server may use built-in full-text indexing facilities of the relational database, which generate compressed index structures and posting lists. For semantic search, the server computes a dense vector embedding for each record, for example by averaging token embeddings or by using a sentence-level encoder from a transformer network. The server stores these vectors in a vector index data structure, such as a space-partitioning index or an approximate nearest neighbor index. The server thereby enables two complementary retrieval modes—keyword-based and similarity-based—that can be combined during query processing.

The terminal provides a graphical user interface that allows the user to input a prompt sentence. The user enters an educational question or requirement, such as:

“Please show me effective ways to create math homework for 1st-year high school students who dislike mathematics.”

“How should I respond to parents who complain that the amount of homework is too much for their children?”

“Give me three concrete examples of homework assignments that improve students' understanding of fractions.”

The terminal sends the prompt sentence and user identification to the server using an application-level protocol over the communication network. The terminal may also transmit device information, locale settings, or grade level preferences, which the server stores as context for personalization.

The server receives the prompt sentence and applies the same natural language processing pipeline as for document text: normalization, tokenization, and optional part-of-speech tagging. The server encodes the prompt sentence into a feature representation, such as a sparse TF-IDF vector and a dense embedding vector. The server then executes a hybrid retrieval procedure. The server submits a full-text query to the relational database, instructing the database engine to search the inverted index for records containing terms related to the prompt sentence and to compute a similarity score. In parallel, the server queries the vector index to perform a semantic-similarity search that identifies records with embeddings close to the prompt embedding according to a distance metric such as cosine similarity or Euclidean distance.

The server merges the results of the full-text search and the semantic-similarity search using a ranking algorithm. The server computes a combined score for each candidate record based on weighted contributions of keyword relevance, semantic similarity, recency, and category match. For example, the server applies a linear combination or a learning-to-rank model trained on historical user feedback. The server selects a subset of top-ranked records and constructs context information by extracting key sentences and metadata from these records. The server orders the context snippets to avoid redundancy and truncates the total length to respect a token budget for the generative AI model.

The server constructs model input data that includes the prompt sentence and the context information in a predefined format. For example, the server organizes the input into sections labeled as instructions, user query, and retrieved context. The server applies heuristics that ensure that the most relevant context appears close to the prompt in the sequence, which improves the attention patterns inside the generative AI model. The server then transmits the model input data to a generative AI model running either on the same server or on a separate inference server.

In one embodiment, the generative AI model is implemented as a multi-layer transformer-based language model with an encoder-decoder or decoder-only architecture. The model comprises an embedding layer, a plurality of self-attention layers with multi-head attention mechanisms, feed-forward neural sublayers, and output projection layers. The server has previously trained, fine-tuned, or adapted this model on a combination of general text corpora and domain-specific educational text. During training, the server minimizes a loss function such as negative log-likelihood of target tokens, using batched gradient descent and backpropagation. The server uses training techniques including positional encoding, layer normalization, and residual connections to stabilize learning. The server may apply curriculum learning by gradually increasing task difficulty or context length during training. At inference time, the server feeds the sequence of tokens representing the prompt sentence and context information into the generative AI model. The transformer layers compute attention weights that focus on relevant portions of the context. The server controls decoding using algorithms such as beam search, nucleus sampling, or top-k sampling, with parameters that balance diversity and determinism. The server may also encode explicit control tokens that instruct the model to output step-by-step procedures, bullet-point lists, or concise summaries. As a result, the model outputs an education-related solution tailored to the user's request, such as a set of math homework templates with grading rubrics, or suggested phrases for communicating with guardians.

The server receives the raw output tokens from the generative AI model and converts them into text. The server performs content checking using rule-based filters and, optionally, auxiliary classification models that detect offensive, unsafe, or irrelevant content. The server performs format adjustment by inserting headings, numbering, or bullet markers according to layout rules stored in a configuration module. The server may annotate the solution with references to the underlying education-related information records, thereby allowing the terminal to display links or citations. The server then packages the formatted text as presentation data and transmits it to the terminal.

The terminal receives the presentation data and renders it in the user interface. The user reads the solution and can submit follow-up prompt sentences that refer to previous solutions. The server maintains a session state that includes past prompt sentences and generated outputs, and the server may include selected past exchanges as context information when performing subsequent retrieval and generation. This iterative interaction improves personalization and allows the system to refine solutions over time.

From a technical perspective, the described architecture improves computer functionality in several ways. First, by converting heterogeneous web documents into structured education-related information records with rich indexes, the server reduces search time and memory consumption during retrieval. The use of combined full-text and vector search with dedicated indexes yields a lower average query latency and a higher recall at a given response time, compared to naive keyword scanning. Second, by aligning the preprocessing pipeline for both documents and prompt sentences, the server ensures consistent tokenization and embedding spaces, which reduces representation mismatch and improves retrieval accuracy. Third, by constructing model input data that includes carefully selected and ranked context information, the server reduces the number of tokens that must be processed by the generative AI model while maintaining or improving answer quality. This leads to reduced computational load on the model hardware and enables a higher throughput of queries per computing resource. Fourth, by applying trained classification and ranking models with explicitly defined objective functions and optimization procedures, the server performs analyses that cannot be replicated by simple manual curation or rigid rule-based systems. The learning models exploit high-dimensional patterns across large datasets, producing category assignments and relevance scores with lower error rates than human operators under similar time constraints.

In addition, the server employs non-conventional processing flows that are different from merely automating human workflows. For example, the server uses vector similarity search and learned ranking over a hybrid index, which is a machine-oriented mechanism that integrates semantic relations in a continuous vector space-such operations have no direct analog in manual document handling. The server also enforces consistency between classification labels and the content of context information by discarding segments whose predicted category probabilities conflict with user-specified requirements. These automated consistency checks reduce logical errors in the final solution.

Alternative embodiments may vary the specific implementations while keeping the same overall data structures and processing principles. In one variation, the server uses a graph database to represent relationships among education-related information records, such as prerequisite relations between concepts or typical progression of learning tasks. The server then incorporates graph traversal results into the context information. In another variation, the server maintains multiple generative AI models of different sizes and capabilities, and the server selects an appropriate model dynamically based on prompt sentence complexity, target response time, or available computational resources. In yet another variation, the server deploys the vector index on a dedicated accelerator or distributed search engine to handle large-scale educational corpora, while the relational database continues to manage metadata and transactional integrity.

In all embodiments, the server, the terminal, and the user cooperate through the described technical mechanisms to enable efficient acquisition, structuring, retrieval, and generative use of educational information. The system thus realizes not only higher-quality educational guidance but also concrete improvements in data management, search efficiency, and computational utilization inside the computer system itself.

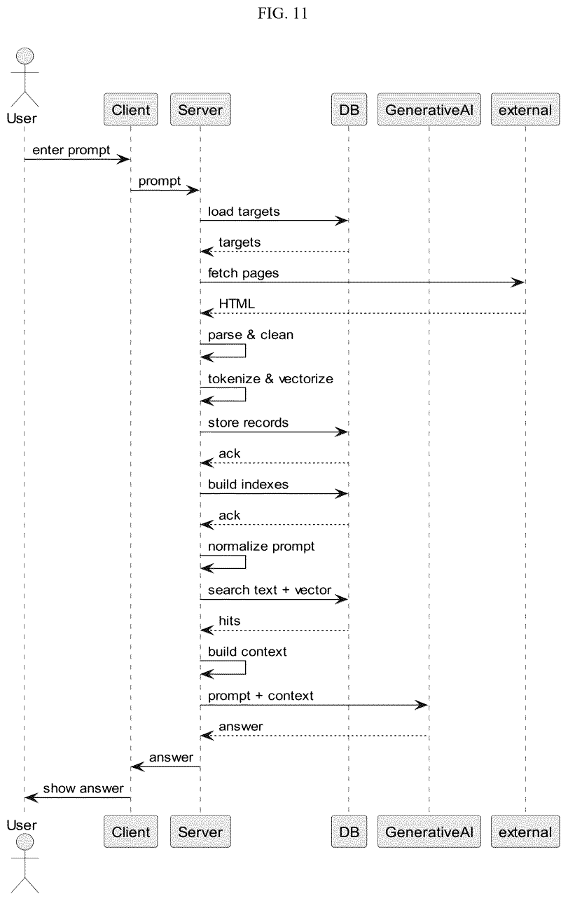

The following describes the processing flow using FIG. 11.

### Step 1:

The server reads, from a configuration table in the database, base location entries that indicate education-related information sources.

Input: existing base location records stored in the database.

Output: an in-memory list of base locations with associated metadata.

The server generates identification information for information-collection targets by combining each base location with query parameters such as subject, grade level, or language. The server concatenates strings, adds query key-value pairs, and assigns unique identifiers. The server then writes these identification records, including constructed resource locators and category hints, into an information-collection-target table in the database.

### Step 2:

The server constructs an information-collection target list by querying the information-collection-target table and filtering records based on freshness, priority flags, or user-specified preferences.

Input: identification records stored in the information-collection-target table.

Output: an ordered list of target entries to be crawled.

The server sorts the targets by priority and last-retrieved timestamp, using a database ORDER BY operation, and materializes the result into an in-memory queue. The server marks selected targets with a “scheduled” status flag in the table to avoid redundant scheduling.

### Step 3:

The server sends HTTP requests to external information processing apparatuses for each entry in the scheduled target queue by using a network communication library.

Input: list of information-collection targets including resource locators and request parameters.

Output: raw HTTP responses containing markup documents or error codes.

The server constructs an HTTP GET or POST request for each resource locator, attaches headers such as user agent and language preference, and transmits the request through the network interface. The server receives responses, checks status codes, and discards unsuccessful responses (for example, 404 or 500) while logging errors. For successful responses, the server extracts the response body as a markup string and associates it with the corresponding target identifier.

### Step 4:

The server stores the received markup strings as unstructured electronic documents in a raw-document table.

Input: response bodies (markup strings) and associated target identifiers.

Output: raw-document records with document IDs, source information, and integrity data.

The server computes a hash value (for example, using a cryptographic hash function) over each markup string to detect duplicates. If a hash already exists in the raw-document table, the server updates the retrieval timestamp without creating a new record. Otherwise, the server inserts a new raw-document record with fields including document ID, target ID, source address, retrieval time, content type, and the markup body.

### Step 5:

The server parses each raw-document record by using a markup parser to construct a node tree.

Input: markup documents stored in the raw-document table.

Output: in-memory node trees representing the document structure.

The server loads a markup string into memory and invokes a document parser that tokenizes tags and text nodes. The server creates a tree where each node represents an element with tag name, attributes, and child nodes. The server then traverses the tree using depth-first or breadth-first search to locate candidate content regions, such as elements with tag names like “article”, “section”, or “div” with content-related class attributes.

### Step 6:

The server extracts education-related body text by applying heuristic filters to the node trees.

Input: node trees with markup structure and text nodes.

Output: normalized text segments containing candidate educational content.

The server calculates, for each candidate node, features such as text length, text-to-markup ratio, and presence of education-related keywords. The server discards nodes when features indicate noise (for example, very short text or low text density). The server concatenates the text of retained nodes, removes remaining HTML entities, and separates paragraphs with newline characters. The server inserts the resulting text segments into an intermediate text table, linked to the original raw-document record.

### Step 7:

The server performs character-string normalization and segmentation on the intermediate text segments.

Input: raw text segments in the intermediate text table.

Output: normalized text entries and token sequences.

The server converts all characters into a standard encoding, normalizes punctuation, converts uppercase letters to lowercase for relevant languages, and replaces specific patterns such as multiple spaces or line breaks with a single separator. The server then applies morphological analysis or word segmentation using a language-specific tokenizer. The server obtains a list of tokens with attributes such as lemma and part-of-speech tag. The server stores normalized text and token lists into a preprocessed-text table and a token table respectively, with foreign keys to the intermediate text table.

### Step 8:

The server computes feature representations of the preprocessed texts for classification and topic estimation.

Input: token sequences and normalized text entries.

Output: feature vectors such as TF-IDF vectors or embedding vectors.

The server calculates token frequencies per document and across the corpus, and then computes TF-IDF values for each token using arithmetic operations over frequency counts. Alternatively or additionally, the server passes the token sequences through a pre-trained embedding model, such as a transformer encoder, to obtain dense vector representations. The server writes these feature vectors into a feature table indexed by text identifier.

### Step 9:

The server assigns education categories and relevance scores to each text segment using a trained learning model.

Input: feature vectors from the feature table.

Output: category labels and numeric relevance scores.

The server feeds each feature vector into a classifier model, such as a neural network or linear classifier. The model computes, for each education category (including at least learning-task creation, evaluation-test creation, and guardian correspondence), probability values using internal matrix multiplications, nonlinear activation functions, and softmax operations. The server interprets the probabilities according to a decision rule, for example assigning a category when the probability exceeds a threshold. The server writes the assigned category labels and relevance scores into an education-related-information record table.

### Step 10:

The server constructs structured education-related information records by combining categorized text, metadata, and summaries.

Input: category labels, relevance scores, normalized text, and source metadata.

Output: structured records prepared for indexing.

The server generates a summary for each record using an extractive summarization algorithm that selects sentences with highest centrality scores in an embedding space. The server fills fields such as record ID, category, summary, main text, source address, retrieval time, and relevance values. The server inserts these structured records into a main content table in the relational database.

### Step 11:

The server creates and updates search indexes for the structured records.

Input: structured education-related information records in the main content table.

Output: full-text indexes and vector indexes supporting efficient search.

The server posts the tokenized main text fields into the full-text index structure provided by the database engine. The server calculates vector embeddings for each record (for example, by applying a sentence encoder to the main text) and inserts these vectors into a vector index structure optimized for nearest-neighbor queries. The server also adds secondary indexes on category fields and timestamp fields to accelerate filtering and sorting.

### Step 12:

The terminal displays an input interface for prompt sentences and transmits user queries to the server.

Input: user actions (keyboard input, touch input) and current UI state.

Output: prompt sentences and associated metadata sent to the server.

The terminal provides a text box and, optionally, dropdown menus for grade level or subject.

The user types a prompt sentence such as “Please show me effective ways to create math homework for 1st-year high school students who dislike mathematics.” The terminal packages the prompt sentence, user identifier, and any selected options into a request message and sends the message to the server over a secure channel.

### Step 13:

The server receives the prompt sentence and generates feature representations for query processing.

Input: prompt sentence and user metadata from the terminal.

Output: normalized query text, token sequence, and query feature vectors.

The server normalizes the prompt text using the same procedure as for document text, then applies tokenization or morphological analysis. The server computes TF-IDF or embedding vectors for the prompt sentence using the same feature extraction pipeline as used for stored records. The server stores temporary query features in memory for use in retrieval.

### Step 14:

The server retrieves candidate education-related information records using hybrid full-text and semantic-similarity search.

Input: query feature vectors and normalized prompt tokens.

Output: a ranked list of candidate records relevant to the prompt sentence.

The server submits a full-text search query to the database using the tokenized prompt terms and obtains a list of matching record identifiers with textual relevance scores. In parallel, the server queries the vector index with the prompt embedding and receives a set of nearest-neighbor records with similarity scores. The server merges these lists by computing a combined score for each candidate using a weighted sum or other ranking function that takes into account keyword relevance, semantic similarity, record freshness, and category match. The server selects the top-N records and outputs their identifiers and combined scores.

### Step 15:

The server generates context information from the selected candidate records.

Input: identifiers and combined scores of top-N candidate records.

Output: a context document containing summarized and formatted excerpts.

The server fetches main text, summaries, and metadata for the candidate records from the main content table. The server selects key sentences from each record using scoring based on relevance and non-redundancy, and assembles these sentences into a structured context document. The server orders the excerpts so that the most relevant and recent content appears first. The server adds simple headings or labels indicating categories or sources and truncates the context if its estimated token length exceeds a configured limit.

### Step 16:

The server builds model input data for the generative AI model using the prompt sentence and the context information.

Input: original prompt sentence and generated context document.

Output: formatted model input data ready for inference.

The server creates a sequence of tokens or text blocks that includes an instruction portion (for example, “Act as an educational advisor.”), the user's prompt sentence, and the context document. The server arranges these elements in a fixed template, separates them with delimiters, and optionally inserts control tokens that indicate desired output style, such as “Output step-by-step instructions.” The server ensures that the total token count remains within the capacity of the generative AI model by trimming less relevant context entries.

### Step 17:

The server invokes the generative AI model to generate an education-related solution.

Input: formatted model input data containing the prompt sentence and context information.

Output: a raw generated text sequence representing a candidate solution.

The server transmits the model input data to a generative AI model hosted on a model server or accelerator. The model processes the input sequence through its layers and produces output token probabilities. The server controls decoding parameters, such as maximum output length and sampling strategy, and receives a sequence of output tokens from the model. The server converts the tokens into text and stores the raw solution text in memory.

### Step 18:

The server post-processes the generated solution and prepares presentation data.

Input: raw solution text from the generative AI model and identifiers of supporting records.

Output: formatted solution text and presentation data for the terminal.

The server scans the raw solution text with content-checking rules to detect prohibited or irrelevant content, and, if necessary, removes or replaces problematic segments. The server formats the text into readable sections, adding headings such as “Background,” “Specific steps,” and “Example assignments,” and converting lists into bullet points or numbered steps. The server optionally appends references to the underlying education-related information records, such as short citations or source labels. The server packages the formatted solution and metadata into a response message and sends it to the terminal.

### Step 19:

The terminal receives the presentation data and displays the generated solution to the user.

Input: response message containing formatted solution text and metadata.

Output: a rendered view of the solution and an updated interaction state.

The terminal parses the response, extracts the solution text and references, and updates the user interface to show the new content. The terminal may enable scrolling, link tapping, or copying of text for later use. The user reads the solution and, if necessary, inputs a follow-up prompt sentence based on the displayed content. The terminal then repeats the request process, and the server repeats the retrieval, context generation, and generative AI model invocation steps for the new prompt sentence.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems that assist educational activities typically rely on simple search engines or static repositories of content. Such systems merely index documents and return keyword-matched items, without deeply structuring the collected information or generating case-specific solutions. As a result, a processor must repeatedly perform costly retrieval and manual filtering operations, and an educator must manually interpret and adapt heterogeneous search results for each individual educational scenario. This leads to inefficiencies in processing, redundant computations for similar queries, and inconsistent quality of the educational solutions provided to end users.

Furthermore, in conventional architectures, large-scale unstructured educational data, such as articles, lesson plans, and policy documents, are not transformed into a form that can be effectively consumed by generative artificial intelligence models. Prompt sentences submitted to such models are often ad hoc, manually composed, and not grounded in a systematically curated and classified data set. Consequently, the underlying computing resources are not optimally utilized: the generative artificial intelligence model is forced to infer solutions from limited or incomplete context, producing variable outputs and requiring repeated inference runs for similar user requests. This results in increased processing time, increased network and storage usage, and reduced reliability of the overall system.

In addition, conventional systems do not store, as structured machine-usable history, the relationships among collected source information, generated prompt sentences, and the resulting solutions. Without such structured history, the processor cannot effectively reuse or adapt previous solutions for new but related requests, and cannot refine prompt-generation logic over time. This prevents the system from learning from prior interactions at the system level, leading to repeated full computations and limiting scalability as the number of users and requests grows.

Therefore, there is a need for a computer-implemented technique that improves the operation of the computing system itself by: (i) systematically acquiring and classifying unstructured educational-related information into a relationally searchable data set, (ii) automatically generating structured prompt sentences that combine user requests with context derived from the classified data, (iii) efficiently interacting with a generative artificial intelligence model based on those prompts, and (iv) storing prompt-solution relationships as history to optimize subsequent retrieval and generation. By reorganizing data flows and internal representations in this manner, the processor can reduce redundant processing, improve relevance and consistency of generated solutions, and enhance the technical performance and scalability of the overall system.

The specific processing by the specific processing unit 290 of the data processing device 12 in Application Example 1 is realized by the following means.

The present invention provides a server comprising a processor and a memory storing instructions that, when executed by the processor, cause the processor to prepare identification information of information sources connected via a communication network; acquire, based on the identification information, unstructured information data including educational-related information from the information sources via the communication network; analyze a structure of the acquired information data and extract educational-related information from character information and associated information by executing character-string processing or natural-language processing; generate classification information by assigning category information and case information to the educational-related information; store the classification information, as records including an item identifier, source information, the category information, and the case information, in a relational data management device so as to accumulate a searchable educational-related information set; execute a query process on the relational data management device based on search conditions including character-string information or the category information and the case information received from a user terminal, and extract and provide related information corresponding to the search conditions from the educational-related information set; generate context information by summarizing or extracting the related information obtained from the relational data management device, generate instruction-sentence data as a prompt sentence including the context information and request information received from the user terminal as an individual request, and output the instruction-sentence data; input the prompt sentence to a generative artificial intelligence model and obtain generated output as solution information corresponding to the context information and the request information from the generative artificial intelligence model; convert the obtained solution information into presentation-format data that a user is able to view or output, and provide the presentation-format data via the user terminal; and store the prompt sentence and the solution information as history information in the relational data management device or in a separate storage device so that the history information is available for use in a subsequent search process or solution-generation process. This enables the computing system to internally restructure unstructured network data into a classification-based relational store, to automatically construct context-rich prompt sentences for a generative artificial intelligence model, and to reuse structured history of prompts and solutions, thereby reducing redundant processing, improving the relevance and consistency of generated solutions, and enhancing overall computational efficiency and scalability.

The term “information source” refers to an information-providing entity accessible via a communication network, such as a server, storage service, or website, from which digital information data can be acquired.

The term “communication network” refers to a data communication infrastructure, including wired or wireless networks, that enables digital information exchange between the server, information sources, and user terminals, and encompasses public networks, private networks, or combinations thereof.

The term “unstructured information data” refers to digital data that is not stored in a predefined tabular or relational schema, such as free-text documents, web pages, or multimedia-associated metadata, and that requires parsing or analysis to extract meaningful elements.

The term “educational-related information” refers to content items associated with education, including but not limited to learning materials, lesson plans, assessment items, policy descriptions, and guidance documents that are usable for planning, conducting, or evaluating educational activities.

The term “character information” refers to textual data composed of characters, symbols, or numerals, such as titles, paragraphs, labels, and annotations contained in the unstructured information data.

The term “associated information” refers to metadata or auxiliary data related to the character information, such as timestamps, authorship information, source identifiers, hyperlinks, tags, or structural markup.

The term “character-string processing” refers to computational operations performed on sequences of characters, including parsing, tokenization, pattern matching, keyword detection, and rule-based extraction, executed to identify and manipulate textual elements.

The term “natural-language processing” refers to a set of computational techniques for analyzing and understanding human language, including language detection, part-of-speech tagging, entity recognition, classification, and semantic analysis, applied to the character information.

The term “classification information” refers to data indicating that specific educational-related information has been assigned to one or more categories or cases, and includes labels or attributes that organize the information into a structured form suitable for search and retrieval.

The term “category information” refers to classification labels representing conceptual groupings of educational-related information, such as subject areas, content types, or pedagogical themes, used to organize and filter stored information.

The term “case information” refers to classification labels representing situational or contextual conditions, such as learner level, class size, learning environment, or specific educational scenarios, used to refine and contextualize stored information.

The term “relational data management device” refers to a data storage and retrieval system that manages structured records according to a relational model, supports operations such as insertion, querying, and updating, and maintains data in tables with defined fields and relationships.

The term “record” refers to a structured data unit stored in the relational data management device, including predefined fields such as an item identifier, source information, category information, and case information, representing a single item of educational-related information.

The term “item identifier” refers to a unique or quasi-unique data element associated with a record, used by the system to distinguish one stored item from another and to reference specific items during processing.

The term “source information” refers to data indicating the origin of the educational-related information, including, for example, a network address, resource identifier, or provider identifier of the information source.

The term “searchable educational-related information set” refers to a collection of records stored in the relational data management device that can be queried using search conditions, such as keywords, categories, or cases, to retrieve relevant educational-related information.

The term “user terminal” refers to a computing apparatus operated by a user, such as a personal computer, tablet, or smartphone, that communicates with the server via the communication network and presents information to the user.

The term “search condition” refers to input data received from the user terminal, including character-string information, category information, and case information, specifying constraints or criteria used by the system to retrieve related information from the searchable educational-related information set.

The term “related information” refers to one or more records or portions of records retrieved from the searchable educational-related information set that satisfy a given search condition or are determined to be relevant to a user's request.

The term “context information” refers to information derived from the related information by summarizing, selecting, or restructuring one or more portions of the related information, and used to provide background or situational detail in a prompt sentence.

The term “request information” refers to data representing an individual user's request, such as a description of a desired solution or scenario, received from the user terminal and used together with the context information to generate a prompt sentence.

The term “prompt sentence” refers to instruction-sentence data formatted for input to a generative artificial intelligence model, including at least the context information and the request information, and specifying a task for the model to perform.

The term “instruction-sentence data” refers to digital data representing one or more sentences or text segments that define instructions, constraints, or background information for use by a generative artificial intelligence model.

The term “generative artificial intelligence model” refers to a computational model, such as a neural network-based language model, that processes prompt sentences and produces generated output in the form of natural-language text or other structured data corresponding to the prompt.

The term “solution information” refers to generated output produced by the generative artificial intelligence model in response to a prompt sentence, the output including proposals, plans, or other responses adapted to the context information and the request information.

The term “presentation-format data” refers to data obtained by converting the solution information into a format suitable for display, printing, or other output at the user terminal, such as structured text, markup, or document data.

The term “history information” refers to stored data representing associations among prompt sentences, corresponding solution information, and optionally related metadata, used for later retrieval, analysis, or reuse in subsequent search or solution-generation processes.

The term “subsequent search process” refers to a processing operation performed after history information has been stored, the operation including using the history information, in addition to or instead of source information, to retrieve or rank educational-related information in response to a new search condition.

The term “solution-generation process” refers to a processing operation in which the system generates a new prompt sentence and obtains new solution information from the generative artificial intelligence model, optionally using previously stored history information to influence or optimize the generation.

In one embodiment, a server includes a processor, a main memory, a non-volatile storage device, a network interface, and executes a program stored in the non-volatile storage device to realize the functions described below. The server is implemented on general-purpose computer hardware such as a rack-mounted computing apparatus including a multi-core central processing unit and, optionally, a graphics processing unit optimized for matrix operations. The server runs an operating system such as a general-purpose server operating system and uses a web application framework such as a server-side framework to provide a network-accessible application. The server uses a relational database management system as a relational data management device, and uses libraries for web document parsing and network communication.

The server acquires digital information from remote information sources via a communication network. The server uses the network interface to send hypertext transfer protocol requests to the information sources and receives digital documents such as markup documents and other structured text files. The server uses a parsing library, for example an HTML/XML parser, to convert the raw markup into a tree structure. The server then performs character-string processing on the textual nodes to segment text, remove markup tags, and normalize character encodings.

The server classifies the extracted textual content as educational-related information by executing a classification program. The server uses rule-based keyword matching and machine-learning-based natural-language processing to identify whether a document or a segment belongs to educational domains such as learning, assessment, policy, or instruction. The server, for example, uses a natural-language-processing library to perform tokenization, part-of-speech tagging, and vectorization of sentences. The server then applies a trained classifier, such as a logistic regression classifier, a gradient-boosting decision tree model, or a shallow neural network, to compute a probability that the content relates to specific categories and cases. The server assigns category information (for example, subject area, content type) and case information (for example, learner level, class size, delivery mode) to each extracted item of educational-related information.

The server stores each classified item in a relational data management device. The server defines table structures including, for example, an item table, a category table, a case table, and a history table. The server stores in the item table fields such as an item identifier, source information, title text, main content text, and timestamps. The server stores category information and case information as normalized references or attributes to maintain a consistent schema and enable efficient indexing. The server creates indexes on frequently queried fields, including keyword indices on title and content fields and composite indices on category and case fields. By maintaining these specific data structures, the server reduces query time and improves cache locality, which results in lower latency when handling frequent search requests.

The terminal operates as a user interface device. The terminal is realized by a general-purpose client device such as a personal computer, tablet, or smartphone equipped with a central processing unit, a display device, an input device, and a communication interface. The terminal runs a web browser or a dedicated client application. The terminal transmits search conditions, including text-based keywords and selections of category and case, to the server via the communication network using hypertext transfer protocol over transport-layer security. The terminal receives response data from the server in a structured format such as marked-up text or structured text and renders the received data on the display device. The terminal presents a list of educational-related items, displays the full content of a selected item, and provides user interface elements for the user to request generation of a case-specific solution.

The user operates the terminal to input request information. The user specifies, for example, an educational objective, a target learner group, a time frame, and constraints on materials. The user types such information into a text input field and may select additional options from dropdown menus. The user then requests a solution generation by activating a control element on the terminal display. The user thereby causes the terminal to transmit the request information along with identifiers of one or more selected educational-related items to the server.

The server generates context information for a generative AI model by processing related information retrieved from the relational data management device. The server first issues a structured query, such as a parameterized structured query language statement, to the relational data management device using the item identifiers and search conditions. The server then obtains a set of relevant records, each including textual content and associated category and case labels. The server executes a summarization algorithm on these records to produce a compact representation suitable for input to a generative AI model.

In one embodiment, the server uses a deterministic extractive summarization method based on scoring sentences by term frequency-inverse document frequency or by centroid similarity in a sentence-embedding space, and selects top-ranked sentences under a length constraint. By using such a structured summarization step, the server limits the volume of context data passed to the generative AI model and removes redundant or low-value segments. This reduction of input length improves inference speed of the generative AI model and reduces network bandwidth usage between the server and a remote AI inference service, thereby improving overall computational efficiency.

The server constructs a prompt sentence for the generative AI model by combining the context information and the user's request information according to a predefined template. The server uses a prompt-construction module that arranges the information into a structured instruction. For example, the server generates a prompt sentence such as:

“Using the following educational contents about middle school mathematics homework, generate a concrete one-week homework plan that emphasizes problem-solving skills.

Include daily assignments, example problems, and brief instructions for students. Contents: [summarized key points].”

As another example, when the user requests guidance on creating evaluation tasks, the server generates a prompt sentence such as:

“Based on the stored educational contents about assessment strategies in high school science, propose five evaluation tasks that measure both conceptual understanding and practical skills. For each task, describe the task, the expected student response, and a scoring rubric.”

In a further example, when the user seeks support for communication with guardians, the server generates a prompt sentence such as:

“Using the following educational policies and prior guardian-communication examples, draft an email to guardians explaining the introduction of daily reading homework for elementary school students, emphasizing benefits, time requirements, and how guardians can support their children”

The server uses these prompt sentences not as arbitrary natural-language instructions, but as structured data that systematically encode both context and request attributes drawn from the relational data management device.

The server transmits the prompt sentence to a generative AI model. In one embodiment, the generative AI model is a transformer-based neural network trained on large-scale textual corpora and fine-tuned on instruction-following tasks. The server calls an inference engine that executes the transformer architecture on a processing unit such as a graphics processing unit or a tensor processing accelerator. The transformer architecture includes an embedding layer to convert discrete tokens into continuous vectors, multiple self-attention layers with multi-head attention mechanisms, feed-forward layers, layer-normalization layers, and an output projection layer to generate token probabilities.

The server configures the generative AI model with parameters such as temperature, top-k or top-p sampling thresholds, and maximum output length. The server encodes the prompt sentence into a sequence of tokens using a tokenization algorithm, and the generative AI model processes the tokens sequentially or in batches using its attention and feed-forward layers. During inference, the model computes attention scores between each token position and all preceding positions, enabling fine-grained conditioning on the context. The model uses a learned weight matrix to map attention outputs into a hidden representation, from which the model predicts a probability distribution over the vocabulary for the next token. The server repeatedly samples or chooses tokens based on this distribution until an end-of-sequence condition is met.

In one embodiment, the generative AI model is trained using a supervised or reinforcement-learning-based instruction-following objective. During training, the server (or an offline training system) uses an objective function such as cross-entropy loss between the model's predicted token distribution and target token sequences. The training system updates model weights by gradient descent or a variant thereof, such as Adam optimization, and uses techniques such as learning-rate scheduling, gradient clipping, and weight regularization. The training corpus includes examples of educational-related prompts and desired responses, augmented by synthetic variations of prompts through data augmentation techniques such as paraphrasing and noise injection. As a result of this training process, the generative AI model learns to efficiently map structured prompt sentences, which include both context and explicit instructions, to coherent and relevant solution information.

The server processes the model's generated token sequence to assemble solution information. The server converts tokens back into text characters and applies post-processing rules, such as enforcing section headings (for example, “Day 1,” “Day 2”), bullet-list formatting, or rubric tables. The server optionally enforces structural constraints by rejecting outputs that violate predetermined patterns and re-invoking the generative AI model with refined constraints. This rule-based post-processing contributes to consistent formatting and improves the usability of the generated solutions on the terminal.

The server stores, in the relational data management device, the association among the prompt sentence, the context information, the request information, and the generated solution information. The server creates a history record that includes a history identifier, references to the underlying item identifiers, the full prompt text, a hash or compressed representation of the solution, timing metadata, and optional user feedback scores. The server indexes this history table by request type, category, case, and similarity metrics computed over the prompt sentence. In subsequent requests, the server can query the history table prior to or in parallel with querying the main educational-related information set.

The server uses this history information to improve computational efficiency and technical performance. For example, when the server detects that a new request information and context information are similar to a previous combination, as measured by a vector-space similarity on prompt embeddings or by hash-based approximate matching, the server can reuse or adapt the previously generated solution information instead of invoking a full new generative AI inference. The server may alter only specific sections that differ, thereby shortening model input length and reducing inference time. As a result, the server reduces compute resource consumption on the generative AI model, decreases network traffic to an external inference service, and shortens response latency perceived by the user.

The server thus performs more than simple automation of a human reasoning step. The server implements a non-conventional data flow and structural coupling between a relational database and a generative AI model, in which the relational database is used not merely as a passive store but as an active context-construction engine. The classification of educational-related information into category and case, the summarization into context information, the templated construction of prompt sentences, and the storage of prompt-solution associations as reusable history collectively change how the underlying computing hardware is used. The server reduces unnecessary large-context inference runs, avoids redundant web crawling and parsing operations by caching structured results, and utilizes specific data structures and indexes to achieve query responses within strict latency bounds even under high user load. The terminal receives the solution information from the server and presents it to the user. The terminal formats the solution in a way that enables direct operational use in educational environments. For example, the terminal displays a one-week homework plan with each day represented as a section containing problem lists and estimated time. The terminal may provide direct export to formats used by learning-management systems or printing systems. The terminal may also display, in a compact form, the prompt sentence that led to the solution, allowing the user to understand the rationale and modify the request if necessary. The user applies the solution information in the real world by adjusting and deploying the generated plans or communications. The user can iteratively refine the request conditions by changing parameters such as time length, difficulty level, or emphasis on conceptual understanding versus procedural fluency. Each new refinement generates new prompt sentences and new solutions, which are stored and indexed by the server as additional history. Over time, this iterative process supports a growing repository of domain-specific solutions that further improves the server's efficiency, because similar future requests can be satisfied partly or wholly by retrieving and adapting previous entries rather than recomputing from scratch.

In alternative embodiments, the server may employ different types of generative AI models, such as sequence-to-sequence models, encoder-decoder transformers, or hybrid retrieval-augmented generation models that combine dense vector retrieval with generative decoding. The server may also use different summarization algorithms, such as supervised neural summarizers or graph-based summarizers, in place of or in addition to extractive methods. In another embodiment, the server may implement additional modules to pre-compute and cache context representations for popular educational scenarios, further reducing processing time at query time.

In yet another embodiment, the server may distribute processing across multiple physical machines. One machine may handle web crawling and initial classification, another machine may host the relational data management device, and a third machine may run the generative AI model inference engine. The server coordinates these components using message queues and asynchronous processing to maintain throughput under high concurrent access. Such distributed architectures further improve the scalability and robustness of the system. By organizing data into explicit category and case structures, by designing prompt sentences that systematically encode relationally derived context, and by persistently storing prompt-solution history for reuse and adaptation, the server improves the way computing resources are used to support generative AI tasks. This specific combination of data structures, algorithms, and module interactions yields technical effects such as faster response times, reduced inference load, improved relevance and structural consistency of generated solutions, and more efficient network and storage utilization, thereby providing an improvement in computer technology itself rather than merely implementing an abstract educational or business practice.

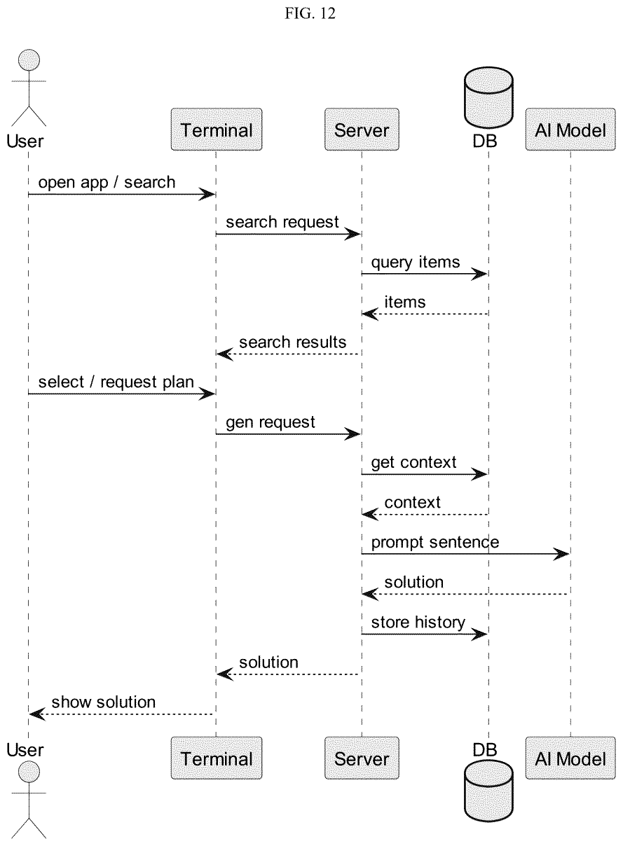

The following describes the processing flow using FIG. 12.

### Step 1:

The server prepares source identification information.

The server receives, as input, configuration data including a list of network addresses, access credentials, and crawling rules stored in a configuration file or database table. The server parses this configuration, validates each entry, and constructs an internal list of information source identifiers (for example, URLs and associated metadata). Based on these identifiers, the server generates a structured schedule and priority order for accessing the sources. The output of this step is a normalized list of information source entries, each including a network address, access parameters, and a next-crawl timestamp.

### Step 2:

The server acquires unstructured information data from information sources.

The server takes, as input, the list of information source entries generated in Step 1. The server uses the network interface to send HTTP or HTTPS requests to the corresponding network addresses and receives digital documents such as HTML pages, XML feeds, or other text-based resources. The server performs status-code checking and retry logic for failed requests. The server aggregates the raw responses into a batch of unstructured information data objects, each including the original response body, headers, and source identifier. The output of this step is a collection of unstructured information data objects stored temporarily in memory or in a staging area.

### Step 3:

The server parses and normalizes document structures.

The server receives, as input, the unstructured information data objects from Step 2. The server invokes a parsing library to convert markup documents into a tree representation (for example, a Document Object Model). The server traverses the tree, extracts textual nodes from tags such as titles, headings, paragraphs, and list items, and removes script and style elements. The server normalizes character encodings, replaces special characters, and segments the text into sentences or paragraphs. The server thereby produces cleaned text and associated metadata such as section labels or hyperlink targets. The output of this step is a set of normalized document objects containing structured fields for title text, body text, auxiliary text, and metadata.

### Step 4:

The server identifies educational-related segments.

The server takes, as input, the normalized document objects from Step 3. The server applies keyword-based filters and a machine-learning classifier to each text segment. The server converts text segments into vector representations using tokenization and embedding techniques, then computes classification scores for educational relevance. Based on these scores and predefined thresholds, the server decides whether each segment constitutes educational-related information. The server discards non-relevant segments and tags relevant segments with an educational relevance flag and a confidence value. The output of this step is a collection of educational-related segments, each with cleaned text, metadata, and relevance scores.

### Step 5:

The server assigns category information and case information.

The server receives, as input, the educational-related segments from Step 4. The server analyzes each segment's text and metadata to infer subject area, content type, learner level, and situational context. The server executes a classification algorithm that may combine rule-based patterns (for example, subject-specific terms) with a trained multi-label classifier. The server computes probability scores for multiple category labels and case labels, selects labels above thresholds, and resolves conflicts using tie-breaking rules. The server appends category information (for example, “mathematics,” “assessment”) and case information (for example, “middle school,” “online class”) to each segment. The output of this step is a set of fully annotated educational-related items ready for storage.

### Step 6:

The server stores annotated items in a relational data management device.

The server takes, as input, the annotated educational-related items from Step 5. The server maps each item to a relational schema including fields for item identifier, source information, title text, main content text, category information, case information, timestamps, and relevance scores. The server constructs parameterized SQL insertion or update commands and sends them to the relational data management device. The server creates or updates indexes on content text, categories, and cases to support efficient querying. After successful insertion and transaction commit, the server records crawl and processing logs. The output of this step is an updated searchable educational-related information set stored in the relational data management device.

### Step 7:

The user initiates a search or solution request via the terminal.

The terminal receives, as input, user actions on an interactive user interface, including text typed into a search or request field and selections made in category and case dropdowns. The terminal packages this input into a request message that includes search conditions or request information and sends the message to the server using HTTP or HTTPS. The terminal displays a waiting indicator while it expects a response. The output of this step is a network request containing user-specified keywords, category filters, case filters, and, optionally, identifiers of previously viewed items.

### Step 8:

The server retrieves related information from the relational data management device.

The server takes, as input, the search conditions or request information received from the terminal in Step 7. The server constructs parameterized SQL queries that search the educational-related information set for records whose content or title matches the character-string conditions and whose category and case fields match the selected filters. The server executes the queries, applies ranking logic based on relevance scores, recency, and user preferences, and limits the result set according to pagination parameters. The server then formats the retrieved records into a structured response, including item identifiers, titles, summaries, and key metadata. The output of this step is a set of related information records suitable for presentation or for use as context in later generation.

### Step 9:

The terminal displays search results to the user.

The terminal receives, as input, the structured related information records from the server in Step 8. The terminal parses the response and updates the user interface to show a list of items with titles, short summaries, and category and case tags. The terminal allows the user to scroll, select items, or refine filters. When the user selects an item, the terminal requests and displays the full content text and metadata. The output of this step is a visual presentation of the related information on the display device, and, optionally, a set of selected item identifiers that the user can choose as context for solution generation.

### Step 10:

The user specifies detailed request information for solution generation.

The user views the presented items on the terminal and decides to request a tailored solution.

The user selects one or more relevant items or leaves them as currently selected, and then enters additional request information, such as desired outcome, time period, difficulty level, or constraints on tasks. For example, the user types “create a one-week middle school math homework plan focusing on problem-solving skills” into a request field. The user confirms the request by interacting with a control element. The terminal takes, as input, the chosen items and typed request information and sends a generation request to the server. The output of this step is a message to the server containing item identifiers and refined request information.

### Step 11:

The server generates context information from related records.

The server receives, as input, the item identifiers and request information from Step 10. The server queries the relational data management device to obtain full content and metadata for the specified items. The server processes these texts with a summarization module that scores sentences by importance (for example, using term frequency-inverse document frequency or embedding similarity) and selects a subset under a length constraint. The server concatenates selected sentences and key metadata into a contextual summary that covers relevant educational strategies, examples, and constraints. The output of this step is context information: a compact representation of the selected educational-related items tailored to the user's request.

### Step 12:

The server constructs a prompt sentence for a generative AI model.

The server takes, as input, the context information from Step 11 and the request information from Step 10. The server applies a prompt-construction algorithm that inserts these elements into a predefined instruction template. The server may include explicit sections, such as “Objective,” “Learner Level,” “Constraints,” and “Context,” to guide the generative AI model. For example, the server produces a prompt sentence of the form:

“Using the following educational contents about middle school mathematics homework, generate a concrete one-week homework plan that emphasizes problem-solving skills. Include daily assignments, example problems, and brief instructions for students. Contents: [context information].”

The server validates the prompt length and adjusts it if necessary. The output of this step is structured instruction-sentence data representing the prompt sentence ready for model input.

### Step 13:

The server invokes the generative AI model and generates solution information.

The server receives, as input, the prompt sentence from Step 12. The server encodes the prompt sentence into tokens using a tokenizer associated with the generative AI model. The server submits the token sequence, along with control parameters such as maximum output length, temperature, and sampling strategy, to an inference engine running the generative AI model. The model performs neural network computations to produce output tokens conditioned on the prompt. The server collects the generated tokens, converts them back into text, and, if necessary, enforces structural rules (for example, section headers or bullet lists) through post-processing. The output of this step is solution information: a textual proposal that addresses the user's request based on the provided context.

### Step 14:

The server stores prompt-solution history.

The server takes, as input, the prompt sentence from Step 12, the solution information from Step 13, and identifiers of the source items used in context generation. The server generates a history record that includes a unique history identifier, references to the item identifiers, the full prompt text, a representation of the solution text, timestamps, and optional user or system metadata. The server inserts this record into a history table in the relational data management device, and updates indexes that enable search by request type, category, case, or similarity of prompts. The output of this step is an extended history information set that can be reused in future search or generation processes.

### Step 15:

The server returns solution information to the terminal.

The server receives, as input, the solution information from Step 13. The server converts the solution into a presentation format, such as structured markup with headings and lists, and packages it in a response message along with summary data (such as a short abstract and estimated reading time). The server sends this response to the terminal using a network protocol. The output of this step is a response message containing formatted solution information suitable for immediate display.

### Step 16:

The terminal presents the generated solution to the user.

The terminal receives, as input, the response message from the server in Step 15. The terminal parses the formatted solution and renders it on the display device, showing sections such as “Day 1,” “Day 2,” and so on, or “Introduction,” “Tasks,” and “Scoring Rubric,” depending on the type of solution. The terminal may also display the prompt sentence or request summary in a separate area, so the user can understand the basis of the generated solution. The terminal provides controls for the user to scroll, print, or export the solution. The output of this step is a visible, usable representation of the generated solution information at the user side.

### Step 17:

The user evaluates and optionally refines the solution.

The user reads the generated solution on the terminal and compares it with the actual needs in the educational setting. The user may adjust parameters such as difficulty, duration, or focus by editing the request field and requesting regeneration. The user may also provide feedback, such as rating or comments, that the terminal sends back to the server as additional metadata. The output of this step is either an acceptance of the solution for real-world use or a refined set of request information that the terminal transmits to the server to trigger another cycle beginning from Step 10 or Step 11.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”

In conventional computer-implemented educational support systems that utilize generative AI models, the computer typically receives free-form text from a user and forwards that text directly, or with only minimal preprocessing, to the generative AI model. In such configurations, the central processing performed by the computer is limited to acting as a conduit between a user interface and an external generative AI engine. As a result, several technical problems arise.

First, the computer does not systematically structure or normalize the user's request or associated educational data before invoking the generative AI model. The processing logic in the computer therefore tends to be ad hoc and highly dependent on the generative AI model's internal behavior. This lack of structured pre-processing leads to inconsistent generation results, difficulty in reproducing outputs, and increased trial-and-error traffic between the client and the server, thereby causing unnecessary consumption of computational resources and network bandwidth.

Second, conventional systems often do not maintain a well-organized, case-based repository of educational information and past solution data within the storage device. The computer therefore cannot efficiently reuse prior cases or curriculum-aligned data when generating new solutions. Instead, the generative AI model must infer context and structure directly from loosely specified prompts, which pushes complex data handling and contextualization into the model itself. This makes the overall system highly dependent on the model's parameterization, reduces controllability from the server side, and may require repeated model calls to refine the output, thus increasing processing latency and server load.

Third, existing systems generally lack a dedicated mechanism by which the processor transforms structured educational data into a systematically formed prompt sentence having a predetermined internal structure. Without such a mechanism, the prompt construction is often embedded as static templates or hard-coded rules at the application level, making it difficult for the server to dynamically vary prompt structure by case type, difficulty level, or user scenario. This limitation constrains the server's ability to optimize prompt content for different categories such as learning task creation, evaluation test creation, or guardian response support, and results in suboptimal utilization of computational resources associated with the generative AI model.

Fourth, conventional systems do not sufficiently post-process the output of the generative AI model into a normalized, structured data representation. Instead, the generated text is typically returned as unstructured strings to the terminal, where any parsing or formatting is handled in a fragmented manner. This architecture causes redundant text manipulation across client devices, increases client-side processing complexity, complicates caching and re-use on the server side, and limits the ability of the server to perform centralized quality control, logging, and indexing of generated solutions.

Accordingly, there is a need for a computer-implemented technique in which the server, rather than merely relaying prompts, performs systematic extraction, classification, and case-based organization of educational data; generates prompt sentences with embedded curriculum summary information and representative case information according to a predetermined structure; invokes a generative AI model using such structured prompt sentences; and post-processes the model output into structured data. By re-architecting the server-side data flow and control over prompt generation and analysis, the technical field requires an improvement in how the computer manages memory access patterns, network traffic to the generative AI model, and internal data representations, thereby improving processing efficiency, consistency, controllability, and scalability of AI-assisted educational support systems.

The specific processing by the specific processing unit 290 of the data processing device 12 in Example 2 is realized by the following means.

The present invention provides a server comprising a processor and a storage device, the processor being configured to receive, from a terminal, a user request and extract learning condition information or response condition information included in the user request, to acquire, based on the learning condition information or the response condition information, educational information and past case information from a communication network and the storage device, to classify the acquired information by case type and difficulty type, to organize the acquired information on a case basis, and to store the organized information in the storage device, to generate, using information stored in the storage device, a prompt sentence including grade information, subject information, learning theme information or response theme information and embedding curriculum summary information and representative case information in a predetermined structure, to instruct a generative AI model to receive the prompt sentence as input, to analyze solution information output from the generative AI model, to extract problem statement information, answer information, and explanation information or response plan information from the solution information, to generate structured data including the extracted information and store the structured data in the storage device, and to transmit solution information based on the structured data to the terminal in a form displayable or outputtable by the terminal. This enables the server to perform centralized, structured pre-processing and post-processing around the generative AI model, thereby improving the efficiency and determinism of memory access and data organization in the storage device, reducing redundant network calls and prompt iterations to the generative AI model, enforcing consistent prompt structures tailored to different educational and guardian-response scenarios, and providing normalized, reusable structured outputs that enhance overall computational performance, scalability, and controllability of the AI-assisted educational support system.

The term “processor” refers to one or more hardware-based computation units, such as a central processing unit or an execution core, configured to execute instructions to perform the processing operations described in the present disclosure.

The term “storage device” refers to one or more non-transitory computer-readable media, such as a magnetic storage medium, an optical storage medium, or a semiconductor memory, configured to store data, programs, and structured information used by the processor.

The term “terminal” refers to an information processing apparatus, such as a client device or user interface device, that communicates with the server via a communication network and is configured to transmit user requests and receive solution information for display or output.

The term “user request” refers to information input by a user via the terminal, including at least one of natural language text, selection data, or parameter data, indicating a requirement for a learning-related solution or a response-related solution.

The term “learning condition information” refers to parameter information extracted from the user request that specifies conditions related to an educational task, including at least one of grade information, subject information, learning theme information, difficulty level information, or number-of-items information.

The term “response condition information” refers to parameter information extracted from the user request that specifies conditions related to a response scenario, including at least one of target attribute information, consultation theme information, communication style information, or constraint information.

The term “educational information” refers to information related to educational content, including at least one of teaching material information, curriculum information, example problem information, learning goal information, or evaluation criterion information.

The term “past case information” refers to information representing previously recorded solution cases, including at least one of historical homework sets, historical evaluation tests, historical guardian response examples, or associated outcome information.

The term “communication network” refers to a wired or wireless data communication infrastructure, such as a local area network, a wide area network, or the Internet, that enables data exchange between the server, the terminal, and external information sources.

The term “case type” refers to a classification category that distinguishes among different usage scenarios, including at least one of learning task creation, evaluation test creation, remedial learning support, or guardian response support.

The term “difficulty type” refers to a classification category that indicates a difficulty level of educational content, including at least one of beginner level, intermediate level, or advanced level.

The term “prompt sentence” refers to structured text generated by the processor, including at least one of grade information, subject information, learning theme information, response theme information, curriculum summary information, or representative case information, and configured to be supplied as input to the generative AI model.

The term “grade information” refers to information indicating an educational level or school year associated with a learner, including at least one of elementary level, secondary level, or higher education level.

The term “subject information” refers to information indicating an educational subject, including at least one of mathematics, language arts, science, social studies, or other curriculum areas.

The term “learning theme information” refers to information indicating a specific educational topic or unit within a subject, including at least one of fractions, decimals, reading comprehension, or scientific phenomena.

The term “response theme information” refers to information indicating a topic of a communication or consultation scenario, including at least one of academic performance concerns, behavioral issues, or home support strategies.

The term “curriculum summary information” refers to condensed information derived from educational information, indicating essential learning goals, covered topics, and expected competencies for a given grade and subject.

The term “representative case information” refers to selected data from past case information that typifies common patterns, structures, or examples relevant to a particular case type, grade, subject, or theme.

The term “generative AI model” refers to a machine learning model configured to generate text or other content based on an input sequence, including a model implementing a neural network architecture that receives the prompt sentence and outputs solution information.

The term “solution information” refers to output generated by the generative AI model based on the prompt sentence, including at least one of problem statement information, answer information, explanation information, or response plan information.

The term “problem statement information” refers to information defining an individual educational question, task, or test item intended for a learner.

The term “answer information” refers to information specifying a solution or correct response corresponding to a problem statement.

The term “explanation information” refers to information describing reasoning, solution steps, or pedagogical commentary associated with a problem statement and its answer.

The term “response plan information” refers to information describing proposed communication steps, phrases, or strategies for handling a consultation or guardian response scenario.

The term “structured data” refers to data arranged according to a predefined schema or format, including at least one of records, fields, lists, or key-value pairs, that enable systematic storage, retrieval, and further processing by the processor.

The term “teaching material information” refers to educational content data, including at least one of textbook excerpts, example exercises, lesson outlines, or reference explanations.

The term “representative example information” refers to one or more example problems or scenarios selected from educational information or past case information and incorporated into the prompt sentence to provide concrete context to the generative AI model.

The term “target attribute information” refers to information describing attributes of a person who is the subject of a response scenario, including at least one of learner grade level, learner academic status, relationship to the guardian, or other demographic or contextual attributes.

The term “consultation theme information” refers to information describing the main topic or issue of a guardian consultation, including at least one of academic progress, motivation, behavioral concerns, or communication methods.

The term “guardian response case information” refers to recorded examples of prior responses to guardians, including at least one of structured conversation plans, example dialogues, or follow-up strategies.

The term “communication guideline information” refers to information defining recommended communication principles, phrasing styles, and procedural steps for interacting with guardians in various consultation themes.

In one embodiment, a server cooperates with one or more terminals operated by users to implement the claimed system. The server includes at least one processor and at least one storage device. The storage device is implemented as a non-transitory computer-readable medium such as a magnetic disk, a solid-state drive, or a semiconductor memory. The processor is implemented as one or more hardware processing units, such as a central processing unit or a graphics processing unit, capable of executing instructions. The terminal is implemented as an information processing apparatus such as a mobile communication device, a tablet device, or a personal computing device that executes a web browser or a native application and communicates with the server via a communication network.

The server executes application software that may be implemented by using an application framework such as a web framework. For example, the server uses a runtime environment and a server-side framework to receive HTTP requests from the terminal, to access a database management system such as a relational database server, and to call an external or internal generative AI model via an application programming interface. The server uses a database driver or an object-relational mapping framework to read and write structured data in the storage device. The server stores educational information, past case information, generated solution information, and structured metadata in database tables or collections.

The server stores program modules that perform at least the following functional roles: a user request reception module, a parameter extraction module, a data retrieval module, a case classification module, a prompt generation module, a generative AI interface module, a solution analysis module, and a structured data management module. Each module is implemented as a set of instructions that the processor executes to perform specific data transformations and data computations on input data structures.

The server uses the user request reception module to receive, from the terminal, a user request and to store the request data in a structured form, such as records having fields for user identifiers, free-text description, grade specification, subject specification, and scenario classification. The server uses the parameter extraction module to parse the free-text description of the user request and to extract learning condition information or response condition information. To perform this parsing, the server uses a natural language processing library that includes tokenization logic, part-of-speech tagging, and named entity recognition. The server represents tokens, part-of-speech tags, and recognized entities in arrays and key-value mappings. The server applies rule-based patterns, such as regular expression patterns and lookup tables, to map recognized entities to grade information, subject information, learning theme information, target attribute information, and consultation theme information. The server uses the data retrieval module to access educational information and past case information stored in the storage device. The server organizes the educational information into database tables such as a curriculum table, a teaching material table, and an example problem table. The server organizes the past case information into tables such as a homework case table, an evaluation test case table, and a guardian response case table. Each record in these tables includes fields for grade, subject, topic, difficulty level, and scenario type. The server executes database queries that specify conditions in terms of grade information, subject information, and theme information to retrieve only records that match the extracted learning condition information or response condition information.

The server uses the case classification module to classify the retrieved educational information and past case information by case type and difficulty type. The server stores predefined difficulty levels, such as beginner, intermediate, and advanced, as categorical values in the storage device. The server may compute a derived difficulty score by applying a scoring function to problem attributes such as number size, number of steps, and presence of distractors. The server groups records into lists or clusters according to case type (for example, learning task creation, evaluation test creation, or guardian response support) and according to difficulty type. The server writes the classification results into indexing structures in the storage device, such as secondary indexes or auxiliary tables, which allow subsequent retrieval by case type and difficulty type with reduced search cost.

The server uses the prompt generation module to generate a prompt sentence that will be supplied to a generative AI model. The server constructs the prompt sentence by filling a predetermined template with specific data values. The template contains placeholders for grade information, subject information, learning theme information or response theme information, curriculum summary information, and representative case information. The server obtains the curriculum summary information by condensing multiple records from the curriculum table into a set of concise textual bullet points, using program logic that selects representative learning goals and topics. The server obtains representative case information by selecting a subset of past case records with high usage frequency or high evaluation scores recorded in the storage device.

The server assembles the prompt sentence as plain text. For example, when the user requires 5th grade mathematics homework about fractions, the server generates a prompt sentence such as:

“You are an experienced elementary school math teacher.

Create 10 math homework problems for 5th-grade students about fractions.

Curriculum summary:
Students learn addition and subtraction of fractions with common denominators.
Students learn comparison of fractions.
Students learn conversion between improper fractions and mixed numbers.

### Representative Examples

1. ¼+ 2/4=?
2. Which is greater: ⅗ or 4/7?

### Requirements:

Start from easy problems and move to difficult ones.
Provide the correct answer for each problem.
Use language appropriate for 5th-grade students.

### Output Format:

1. [Problem]
   Answer: [Answer]
2. [Problem]
   Answer: [Answer]
      . . . .”

In another example, when the user requires advice for a guardian response scenario, the server generates a prompt sentence such as:

“You are an elementary school teacher with extensive experience in communicating with guardians.

A guardian is worried that their child is not keeping up with 5th-grade math.

Based on the following past examples and guidelines, propose a step-by-step communication plan for a 15-minute meeting with the guardian.

### Past Examples

Example 1: Summary of a previous meeting where the teacher explained current performance and offered specific home practice suggestions.
Example 2: Summary of a previous meeting where the teacher coordinated support between home and school.

### Guidelines:

Listen empathetically.
Explain the current level objectively.
Suggest specific support measures at home and at school.

### Requirements:

Use polite, professional language.
Include example phrases that the teacher can actually use during the conversation.
Structure the plan in clear steps (Step 1, Step 2, . . . ).”

The server presents these prompt sentences to a generative AI model through the generative AI interface module. The generative AI model is implemented as a neural network based language model that uses a transformer architecture. The model comprises multiple layers of self-attention sublayers and feed-forward sublayers, and maintains parameters in the form of weight matrices and bias vectors stored in a separate model storage. The server represents input text tokens as integer token identifiers, and uses an embedding matrix to convert the token identifiers into continuous vector representations. The model processes sequences of token embeddings through the transformer layers, computing attention scores and contextually weighted combinations of token vectors, and produces a probability distribution over possible next tokens for each position in the output sequence.

The server stores a configuration for the generative AI model in the storage device, including vocabulary size, embedding dimension, number of transformer layers, number of attention heads per layer, and maximum sequence length. During model training, which may be performed offline, a loss function such as cross-entropy loss is minimized using an optimization algorithm such as stochastic gradient descent or a variant such as Adam. The model adjusts weight parameters based on gradients computed by backpropagation through the transformer layers. The training data includes large collections of text sequences, and may additionally include specialized educational content and guardian communication examples. The server may perform data augmentation by rephrasing questions, randomizing numerical values within constraints, or permuting example orders in the training data, and the training logic stores augmented data in the storage device.

At inference time, the generative AI interface module of the server converts the generated prompt sentence into tokens, feeds the tokens through the model, and applies a decoding strategy such as greedy decoding or sampling with temperature and top-k or nucleus sampling. The server controls these decoding parameters explicitly to balance diversity and determinism in the generated output. By standardizing the prompt structure and the decoding configuration, the server stabilizes the behavior of the generative AI model and improves reproducibility and controllability of generated content.

The server uses the solution analysis module to process the raw text output of the generative AI model. The server applies parsing rules to identify numbered list items, markers such as “Answer:” and “Step 1:”, and section headings. The server defines a parsing grammar that recognizes patterns in the output text and converts them into structured data objects. For example, the server converts each problem and its answer into a structured record having fields for problem number, problem text, answer text, and optional explanation text. The server stores these records as rows in a table or as elements in a structured document such as a key-value tree. The server also indexes the structured data by grade, subject, topic, and case type to enable efficient retrieval.

The server uses the structured data management module to write the structured solution information to the storage device and to manage updates, caching, and retrieval. The server may maintain a cache of frequently requested solution patterns in a memory-based storage to reduce latency and to limit the number of calls to the generative AI model. The server may compress structured data using a compression algorithm before writing it to the storage device to reduce storage space and I/O bandwidth.

The terminal operates as the user-side interface. The terminal executes a web browser or a dedicated application to display screens for inputting user requests and for viewing generated solutions. The terminal transmits user input to the server using a predefined communication protocol over a network. The terminal receives solution information from the server in a structured form and renders the content on the display. The terminal may present the problems and answers in separate views, or may allow the user to toggle answer visibility, print the content, or export the content to an external device. The terminal thereby reduces its own processing load by relying on the server to supply well-structured solution data.

The user operates the terminal to enter educational requirements or guardian consultation requirements. The user may specify structured fields such as grade and subject, and may also input free-text descriptions. The user can interactively refine the request in response to the solutions displayed on the terminal. The user does not need to understand details of the generative AI model or the prompt structure; the server performs these internal operations transparently.

The described configuration improves computer technology in several ways. Because the server classifies educational information and past case information by case type and difficulty type, and because the server generates prompt sentences that embed curriculum summary information and representative case information in a predetermined structure, the server can provide the generative AI model with context that is already pre-normalized and filtered. This reduces the amount of computation performed by the generative AI model to infer context from raw, unstructured instructions. As a result, the model can converge to suitable outputs with fewer tokens and less iterative refinement, thereby reducing computational load and latency.

Because the server converts the output of the generative AI model into structured data and stores it with indexes, the server can reuse generated solutions in a systematic manner. This reduces the number of redundant calls to the generative AI model for similar user requests, thereby reducing network load and processing overhead. The server can retrieve previously generated structured data by key and partially reuse or adapt it for new requests, which improves response speed and reduces unnecessary computation.

Because the server centralizes parsing, classification, prompt generation, and output structuring in a single architecture, the server can optimize memory access patterns in the storage device. For example, by precomputing and storing indexes by grade and subject, the server reduces the number of full-table scans and improves cache hit rates in the database management system. This leads to lower I/O overhead, reduced processing time per request, and improved scalability as the number of users increases.

Because the generative AI model is controlled through standardized prompt sentences and parameterized decoding strategies, the server can systematically tune and monitor the model's performance. The server can record statistics such as average generation length, per-token latency, and entropy of the output distribution. The server may adapt decoding parameters based on these statistics, for example, by lowering temperature to reduce variability when high determinism is required. These control loops improve the reliability and quality of generated solutions in a way that cannot be achieved by manual human authors or by simple text relaying.

The technical effect is not limited to automating human authorship. The system introduces structured intermediate representations, explicit data schemas, and specific control over a neural network-based generative AI model. These features enable the server to manage educational data and guardian response data in a way that optimizes storage operations, database queries, and network communications. The combination of case-based data organization, structured prompt generation, and structured output analysis yields a technical improvement in how the computer stores, retrieves, and processes data.

In another embodiment, the server uses an internal generative AI model executed on a graphics processing unit. The server loads the neural network weights from the storage device into GPU memory, and the processor coordinates data transfer between main memory and GPU memory. The server packs token sequences into batches to utilize parallel processing in the transformer model. This batching reduces per-request computational overhead and increases throughput. The server may adjust batch size based on queue length, thereby controlling trade-offs between latency and throughput.

In another embodiment, the server uses a different natural language processing method in the parameter extraction module, such as a smaller transformer-based classifier trained specifically to categorize user requests by scenario and subject. This classifier uses a supervised learning procedure with cross-entropy loss and gradient-based optimization. The classifier maps user request text into a fixed-dimensional feature vector using an encoder and applies a linear layer with softmax activation to generate probabilities for scenario labels. The server stores the classifier outputs with confidence scores, and uses these scores to resolve conflicts between user-selected fields and extracted intent.

In yet another embodiment, the server maintains multiple prompt templates for different case types. For learning task creation, the prompt template emphasizes curriculum summary information and representative example problems. For evaluation test creation, the prompt template emphasizes coverage of learning objectives and constraint conditions such as time limits and difficulty distribution. For guardian response, the prompt template emphasizes communication guideline information and past guardian response case information. The server selects a template according to the case type and fills it with case-specific data from the storage device. This modularity of templates allows the server to maintain and improve prompt structures independently for different technical scenarios.

In a further embodiment, the server logs all intermediate artifacts, including extracted parameters, selected database records, generated prompt sentences, model outputs, and parsed structured data, together with timestamps and processing identifiers. The server analyzes these logs to identify bottlenecks in database access, network communication with the generative AI model, or parsing logic. The server then adjusts indexes, caching policies, or parsing rules to improve performance. This feedback-driven refinement demonstrates that the invention is directed to continuous improvement of computer operation rather than solely to an abstract intellectual process.

Through these embodiments, the server, the terminal, and the user cooperate to realize a system in which the server's internal architecture-comprising specific data structures, algorithmic modules, and neural network control logic-improves the technical functioning of computer-based educational support and guardian response support, rather than merely automating a human mental process.

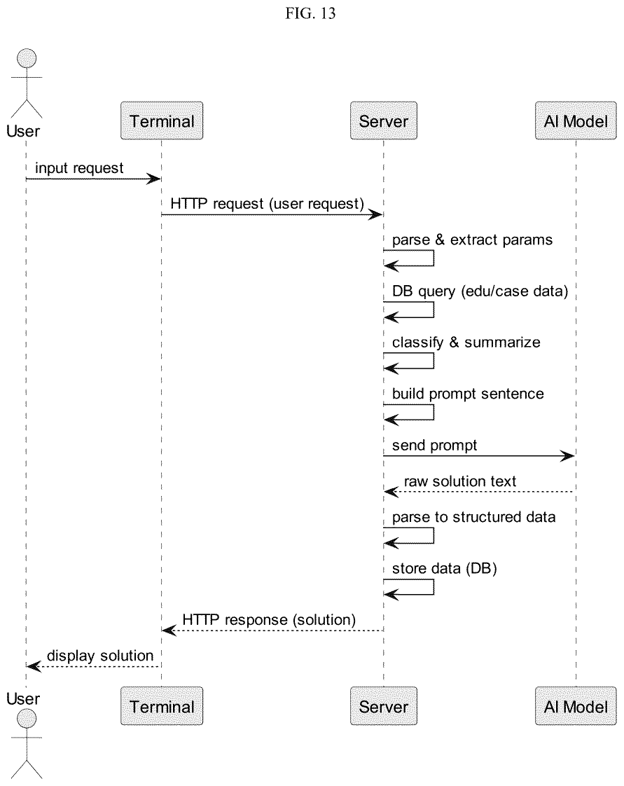

The following describes the processing flow using FIG. 13.

### Step 1:

The user operates the terminal to input a request.

The user enters, into an input screen on the terminal, information such as grade, subject, and a free-text description (for example, “I want to create math homework for 5th-grade students about fractions.”).

The terminal takes, as input, the user's keystrokes and selection operations and converts them into a structured request object containing fields such as grade, subject, scenario type, and free-text description. Based on this input, the terminal performs client-side validation (for example, checking that mandatory fields are not empty) and then serializes the request object into a message format such as JSON. The terminal outputs this serialized request message and sends it to the server over a communication network using an HTTP request.

### Step 2:

The server receives and parses the user request.

The server takes, as input, the HTTP request transmitted from the terminal, including the serialized request message in its body. The server uses a web framework to parse HTTP headers and the body, and to deserialize the JSON-formatted message into an internal data structure such as a record or an object instance. Based on this input, the server performs syntactic validation, checks the presence of grade, subject, and scenario fields, and normalizes text encoding and whitespace. The server outputs a validated and normalized request object, which is stored in working memory for subsequent processing.

### Step 3:

The server extracts learning condition information or response condition information.

The server takes, as input, the normalized request object including structured fields and free-text description. The server applies a natural language processing routine to the free-text description, performing tokenization, part-of-speech tagging, and entity extraction to detect mentions of grade, subject, learning theme, target attributes, and consultation themes. The server combines these extracted entities with the structured fields in the request object and resolves conflicts by predefined priority rules. Based on this input, the server performs data processing that maps phrases to canonical codes (for example, mapping “fifth grade” and “grade 5” to a unified grade code). The server outputs learning condition information or response condition information as a parameter set that includes at least grade information, subject information, and theme information.

### Step 4:

The server retrieves educational information and past case information from the storage device.

The server takes, as input, the parameter set including grade information, subject information, and theme information. The server constructs database queries with conditions such as grade code, subject code, topic identifier, and scenario type. The server executes these queries against database tables containing curriculum records, teaching material records, example problem records, homework case records, test case records, and guardian response case records. Based on this input, the server performs data retrieval operations that filter rows and project relevant columns (for example, unit titles, learning goals, problem texts, and case descriptions). The server outputs collections of matching records as educational information and past case information loaded into memory.

### Step 5:

The server classifies the retrieved information by case type and difficulty type.

The server takes, as input, the educational information and past case information retrieved from the storage device. The server reads fields such as scenario type, topic, and difficulty level from each record and assigns each record to a case type category (for example, learning task creation, evaluation test creation, or guardian response) and a difficulty type category (for example, beginner, intermediate, or advanced). When explicit difficulty is missing, the server computes a derived difficulty score by applying a scoring function to attributes such as numerical range, number of steps, or linguistic complexity. Based on this input, the server performs classification and grouping operations, organizing records into lists or clusters keyed by case type and difficulty type. The server outputs grouped and labeled information structures and writes classification indexes into the storage device to enable efficient future access.

### Step 6:

The server generates curriculum summary information and representative case information.

The server takes, as input, the grouped educational information and past case information categorized by case type and difficulty type. The server selects a subset of curriculum records that collectively cover the relevant grade and topic, and condenses their learning goals and descriptions into short summary sentences. Similarly, the server selects representative example problems or guardian response cases based on usage frequency or evaluation scores recorded in metadata. Based on this input, the server performs data reduction and summarization, concatenating and formatting selected text segments into coherent bullet points and example lists. The server outputs curriculum summary information and representative case information as structured text segments ready to be embedded into a prompt sentence.

### Step 7:

The server constructs a prompt sentence for the generative AI model.

The server takes, as input, the parameter set (including grade, subject, and theme), the curriculum summary information, and the representative case information. The server chooses a prompt template according to case type (for example, a template for homework creation, test creation, or guardian response) and replaces placeholders with the actual parameter values and text segments. Based on this input, the server performs string concatenation, insertion of headings, and formatting of numbered lists to form a coherent prompt sentence. The server outputs a complete prompt sentence in plain text, such as:

“You are an experienced elementary school math teacher.

Create 10 math homework problems for 5th-grade students about fractions.

### Curriculum Summary:

Students learn addition and subtraction of fractions with common denominators.
Students learn comparison of fractions.
Students learn conversion between improper fractions and mixed numbers.

### Representative Examples

1. ¼+ 2/4=?
2. Which is greater: ⅗ or 4/7?

### Requirements:

Start from easy problems and move to difficult ones.
Provide the correct answer for each problem.
Use language appropriate for 5th-grade students.

### Output Format:

1. [Problem]
   Answer: [Answer]
2. [Problem]
   Answer: [Answer]

### Step 8:

The server supplies the prompt sentence to the generative AI model and obtains raw solution text.

The server takes, as input, the generated prompt sentence and a configuration specifying model identifier and decoding parameters. The server converts the prompt sentence into a sequence of tokens using a tokenizer associated with the generative AI model, and then issues an inference request to the generative AI model via an application programming interface. The generative AI model, implemented as a transformer-based neural network with multiple attention layers and learned weight parameters, computes probability distributions over possible output tokens and generates an output text sequence according to the decoding strategy. Based on this input, the server performs marshalling of tokens, network transmission to the model runtime, and reception of the generated token sequence from the runtime. The server decodes the tokens back into characters and words. The server outputs raw solution text that contains, for example, problem statements with corresponding answers or stepwise communication plans.

### Step 9:

The server analyzes the raw solution text and converts it into structured data.

The server takes, as input, the raw solution text generated by the generative AI model. The server applies parsing rules that search for patterns such as numbered list prefixes (“1.”, “2.”, etc.), labels like “Answer:” and “Step 1:”, and line breaks indicating boundaries between items. Based on this input, the server performs text segmentation, splitting the solution text into segments corresponding to individual problems, answers, explanations, or response steps. The server then maps each segment to fields of a structured record, such as problem number, problem text, answer text, and explanation text, and assembles these records into an array or table. The server outputs structured data representing the solution information in a normalized schema.

### Step 10:

The server stores and indexes the structured solution data in the storage device.

The server takes, as input, the structured data produced from the raw solution text and associated metadata such as grade, subject, theme, case type, and timestamp. The server constructs database insert operations to write each structured record into appropriate tables, and updates secondary indexes keyed by grade, subject, and case type. Based on this input, the server performs database transactions that ensure consistency and durability, and optionally applies compression or caching policies. The server outputs persistent records in the storage device that can be efficiently retrieved for future requests and statistical analysis.

### Step 11:

The server prepares a response message and sends it to the terminal.

The server takes, as input, the structured solution data and metadata needed for display, such as titles and layout hints. The server converts the structured records into a response format appropriate for the terminal, such as a hierarchical object containing lists of problems and answers, and attaches status codes and messages indicating successful processing. Based on this input, the server performs serialization into a wire format such as JSON and encapsulates the serialized data in an HTTP response. The server outputs the HTTP response message and transmits it to the terminal over the communication network.

### Step 12:

The terminal renders the solution information for the user.

The terminal takes, as input, the HTTP response from the server containing the serialized structured solution data. The terminal deserializes the response body into an internal representation and maps each problem and answer to user interface elements such as text blocks, list items, or buttons to toggle answer visibility. Based on this input, the terminal performs layout calculations, populates the display with formatted text, and may provide additional actions such as printing or exporting. The terminal outputs a rendered screen that presents the generated problems, answers, or response plans to the user in an interactive and readable form.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that utilize machine learning or generative artificial intelligence models typically treat external data, user context, and model prompts as loosely coupled elements. In many cases, such systems simply pass raw user input to a generative AI model without systematically structuring upstream data, without encoding task constraints and user state as explicit prompt elements, and without closing the loop by feeding downstream usage feedback back into prompt generation logic. As a result, several technical problems arise in the operation of computing resources.

First, a processor tends to issue generic or poorly constrained prompt sentences to the generative AI model. Because such prompt sentences are not derived from a normalized information set that combines higher-level classification items, case-based classification items, and computed feature data of the user or institution, the generative AI model must internally infer the task, constraints, and context from incomplete input. This increases computational load on the model, leads to unstable or low-relevance outputs, and often requires repeated model calls and manual corrections by the user, thereby wasting processing cycles, memory bandwidth, and network resources.

Second, known systems do not effectively integrate structured logs of user operations, learning activity information, service use information, and emotion information from an emotion recognition device into the core control flow of prompt construction. Emotion information and performance indicators, if used at all, are applied as ad-hoc filters or post-processing heuristics. The processor does not systematically associate evaluation results with specific prompt sentences and corresponding model outputs in a way that can be machine-processed to refine subsequent prompts. Consequently, the system cannot adapt its behavior at the level of prompt-sentence generation rules or model use conditions, and the computing platform cannot progressively optimize the effectiveness and predictability of the generative AI model when deployed at scale.

Third, conventional architectures treat generated content as terminal output rather than as a first-class, structured data entity. Generated learning plans, assignments, tests, response plans, or product proposals are often handled as unstructured text streams that are simply displayed by a terminal device. Without converting such content into higher-level data formats, linking it to underlying information sets, and tracking edits performed by the user, the processor cannot perform meaningful offline analysis, caching, or reuse. This causes redundant computation when similar requests recur, increases latency for end-users, and degrades the scalability and efficiency of the generative AI backend.

Fourth, the lack of a unified pipeline that starts from identification information, traverses acquisition and classification of external information, computes feature data, constructs prompt sentences with explicit task content, constraint conditions, and emotion information, and then feeds back structured evaluation results, prevents the system from operating as a self-optimizing computing system. The processor cannot automatically tune prompt templates, sampling parameters, or model selection strategies in response to real-world performance. Therefore, the computer technology itself-namely, the orchestration of data acquisition, data structuring, prompt generation, generative inference, and feedback-driven adaptation-remains static and inefficient.

Accordingly, there is a need for a system and method in which a processor: (i) constructs and maintains a structured information set from heterogeneous external sources; (ii) computes feature data by associating user histories and evaluation data with the structured information set; (iii) generates prompt sentences for a generative AI model that explicitly encode task content, constraint conditions, and emotion information derived from the feature data; (iv) converts model outputs into higher-level data formats; and (v) uses structured evaluation results and their association with particular prompt sentences and model outputs to adaptively update prompt-sentence generation rules and model use conditions. Such a system would improve the efficiency, reliability, and scalability of computer-implemented generative AI workflows, and would reduce unnecessary computational iterations and manual adjustments in downstream applications such as learning support, institutional decision support, and service provision.

The specific processing by the specific processing unit 290 of the data processing device 12 in Application Example 2 is realized by the following means.

The present invention provides a server comprising a processor configured to prepare identification information indicating an information collection target, to acquire, through a communication network, information including education-related information on the basis of the identification information, to analyze the acquired information and classify the acquired information according to higher-level classification items and case-based classification items to generate a structured information set, to store the structured information set in a storage device and associate learning history information or work history information and performance information or evaluation information with the stored information set to calculate feature data, to generate, on the basis of the feature data and the higher-level classification items and the case-based classification items included in the information set, a prompt sentence including task content, constraint conditions, and emotion information for input to a generative AI model and to cause the prompt sentence to be input to the generative AI model, to obtain, from the generative AI model, solution information including at least one of a learning plan, an assignment set, an evaluation test plan, a response plan, and a product proposal generated in response to the prompt sentence and to convert the solution information into a higher-level data format and store the converted solution information in the storage device, to evaluate effectiveness of the solution information on the basis of at least one of operation information, learning activity information, and service use information acquired from a terminal device and emotion information acquired from an emotion recognition device or an emotion recognition function and store an evaluation result in association with the information set and the prompt sentence, to update a prompt-sentence generation rule or a model use condition on the basis of a relationship among the stored evaluation result, the prompt sentence, and an output of the generative AI model and adaptively optimize a subsequently generated prompt sentence and subsequently generated solution information, and to provide the solution information to a user via the terminal device and acquire edited solution information from the user and store the edited solution information again. This enables the computing system to structurally manage external information and user state, to generate context-rich prompt sentences that reduce unnecessary load on the generative AI model, to represent model outputs as reusable structured data, and to close a feedback loop in which evaluation results automatically refine prompt-generation logic and model-use policies, thereby improving the technical performance, efficiency, and scalability of computer-implemented generative AI processing.

The term “identification information” refers to data indicating a target of information collection, including at least one of an identifier, a category, a domain, or a condition used by a processor to specify information to be acquired from an external source.

The term “information collection target” refers to content or a data group to be retrieved from one or more external systems or networks, such as documents, records, or datasets relating to a particular domain, category, or case.

The term “communication network” refers to an infrastructure that enables electronic transmission and reception of data between the server, external information sources, and terminal devices, including at least one of a wired network, a wireless network, or the Internet.

The term “education-related information” refers to information associated with teaching, learning, or educational administration, including at least one of curricula, instructional materials, assignments, tests, policies, guidelines, or performance records.

The term “higher-level classification item” refers to a classification label that represents a broad category or abstraction of information, such as a grade level, subject area, topic group, or organizational category.

The term “case-based classification item” refers to a classification label that represents a specific situation, scenario, or use case, such as a particular learning difficulty, evaluation condition, service context, or institutional case.

The term “structured information set” refers to a collection of information that has been normalized and organized by the processor according to predetermined schemas or data models, such as records, tables, or objects, in which elements are associated with classification items and attributes.

The term “storage device” refers to a physical or logical data storage resource accessible by the processor, including at least one of a main memory, a secondary storage, or a network storage, in which the structured information set and related data are stored.

The term “learning history information” refers to data indicating a sequence or summary of learning activities of a user, including at least one of completed tasks, accessed materials, timestamps, and progression metrics.

The term “work history information” refers to data indicating a sequence or summary of operations or tasks performed by a user or an organization, including at least one of executed procedures, handled cases, or processed requests.

The term “performance information” refers to data indicating quantitative or qualitative results of learning or work, including at least one of scores, grades, accuracy rates, completion times, and achievement levels.

The term “evaluation information” refers to data representing an assessment of outcomes or processes, including at least one of ratings, qualitative reviews, judgments, or compliance indicators.

The term “feature data” refers to derived data computed by the processor from raw information such as histories and evaluations, and used as input for decision making or model processing, including at least one of statistical indicators, aggregated values, or encoded attributes.

The term “emotion information” refers to data representing an estimated emotional state of a user, including at least one of labels such as stress, anxiety, or joy and associated intensities or probabilities.

The term “prompt sentence” refers to a natural-language or structured instruction generated by the processor for input to a generative AI model, the instruction explicitly encoding task content, constraint conditions, emotion information, or other context.

The term “task content” refers to information indicating what operation or output is requested from the generative AI model, including at least one of a request to generate a plan, a set of items, a draft, or a guideline.

The term “constraint conditions” refers to information defining limitations or requirements for the output of the generative AI model, including at least one of time constraints, difficulty ranges, length limits, or policy constraints.

The term “generative AI model” refers to a trained computational model that receives an input such as a prompt sentence and generates new data or content, including at least a natural-language model that produces text as an output.

The term “solution information” refers to content generated by the generative AI model in response to a prompt sentence, including at least one of a learning plan, an assignment set, an evaluation test plan, a response plan, or a product proposal.

The term “learning plan” refers to structured information indicating a sequence, schedule, or organization of learning activities for a user, including at least objectives, steps, and recommended materials.

The term “assignment set” refers to a group of tasks or questions prepared for learning or practice, including at least problem statements, exercises, or instructions.

The term “evaluation test plan” refers to a structured description of one or more tests used to assess performance, including at least test items, formats, and scoring criteria.

The term “response plan” refers to structured information indicating recommended actions or communications for a particular case, including at least scripts, procedures, or decision steps.

The term “product proposal” refers to information indicating one or more recommended products or services for a user or customer, including at least item descriptions and reasons for recommendation.

The term “higher-level data format” refers to a structured representation of solution information that is abstracted or organized beyond raw text, including at least one of hierarchical data, tagged entries, or machine-readable records.

The term “terminal device” refers to an information processing device operated by a user and communicatively connected to the server, including at least one of a handheld device, a portable device, or a workstation.

The term “operation information” refers to data representing how a user interacts with the terminal device or system, including at least one of input operations, navigation actions, selection results, or editing actions.

The term “learning activity information” refers to data representing behaviors of a user during learning, including at least one of selected tasks, answer submissions, viewing of explanations, and time spent.

The term “service use information” refers to data representing how a user or customer utilizes provided services, including at least access patterns, requested services, and response outcomes.

The term “emotion recognition device” refers to hardware or software components configured to estimate an emotional state of a user from input data, including at least sensors and analysis algorithms.

The term “emotion recognition function” refers to processing logic executed by the server or another processor that analyzes input data such as text, audio, or images to estimate emotion information.

The term “evaluation result” refers to data indicating a computed or recorded assessment of effectiveness or quality of solution information, including at least one of numerical scores, categorical labels, or aggregated statistics.

The term “prompt-sentence generation rule” refers to a rule set or parameter configuration used by the processor to transform feature data, classification items, and other context into a prompt sentence for the generative AI model.

The term “model use condition” refers to a parameter or policy controlling how the generative AI model is invoked, including at least one of model selection, sampling settings, or resource limits.

The term “adaptively optimize” refers to a process in which the processor automatically adjusts at least one of prompt-sentence generation rules or model use conditions based on accumulated evaluation results to improve future outputs.

The term “edited solution information” refers to solution information after modification by a user, including at least added, deleted, or changed elements relative to the original content generated by the generative AI model.

In one embodiment, a server implements the claimed system by executing a control program on one or more processors, and by cooperating with one or more terminal devices operated by a user. The server includes a central processing unit, a main memory, a non-volatile storage device, a network interface, and optionally an accelerator such as a graphics processing unit. The terminal includes at least one input device, a display device, a microphone, a camera, a local processor, a memory, and a communication interface. The server and the terminal communicate over a communication network such as the Internet using standardized protocols.

The server executes an operating system and application software comprising a web server module, an API module, a data management module, a prompt-generation module, a generative-AI interface module, an evaluation module, and a model-adaptation module. The server uses a database management system, such as a relational database system or a document-oriented database, as a storage device for a structured information set, user histories, evaluation results, and configuration parameters. The server optionally uses an in-memory key-value store as a cache for frequently accessed feature data and intermediate results.

The server acquires information including education-related information from external sources by using a communication library and an HTTP client. The server retrieves data from external content servers or open data interfaces, and decodes received HTML, XML, or JSON data. The server parses textual data with a natural language processing library such as a tokenizer, a part-of-speech tagger, and a named-entity recognizer. The server assigns higher-level classification items, such as subject area, grade level, and general topic, and assigns case-based classification items, such as “exam preparation,” “low performance,” or “time-constrained study,” to each record. The server then normalizes the parsed data into a structured information set represented as tables or documents with fields for classification items, key phrases, statistical attributes, and linkage to source identifiers.

The server associates learning history information, work history information, performance information, and evaluation information with the structured information set. The server stores for each user a series of records including identifiers of tasks performed, timestamps, results (such as scores or correct/incorrect flags), and usage context (such as device type or session duration). The server computes feature data from these records by aggregating per-topic success rates, computing moving averages of scores, estimating mastery levels with probabilistic models, and calculating typical completion times. In addition, the server stores emotion information obtained from an emotion recognition device or an emotion recognition function. The server derives this emotion information from text, audio, or image signals, and encodes it as an emotion label and an intensity value.

The server implements the generative AI model as a neural network model deployed on one or more accelerator devices or as a client of a remote AI service. In one embodiment, the generative AI model is a transformer-based language model comprising multiple attention layers, feed-forward layers, and residual connections, trained on a corpus of text. The server stores model parameters as weight matrices and bias vectors in a model repository. In an alternative embodiment, the generative AI model is a sequence-to-sequence model or a decoder-only model with token embeddings, positional encodings, and multi-head self-attention.

The server prepares a prompt sentence by executing the prompt-generation module. The server first selects, from the structured information set, records related to the current user or task based on higher-level classification items, case-based classification items, and feature data. The server then encodes task content, such as “generate a learning plan,” “generate an evaluation test,” “generate a response plan,” or “generate a product proposal,” explicitly in natural language. The server encodes constraint conditions, such as a time limit, target difficulty range, and length constraints, as part of the prompt sentence. The server further encodes emotion information, such as “the user is feeling stress” or “the user is feeling anxiety,” as an explicit instruction to the generative AI model to adjust tone and structure. In one example, the server generates the following prompt sentence for a learning assignment scenario:

“The user is a 2nd-year junior high school student who is weak in quadratic equations. The user is feeling stress and has only 30 minutes to study. Using the following topics and past scores, generate a set of 10 practice problems on quadratic equations for the user, with problems from basic to intermediate level and short step-by-step explanations that can be completed within 30 minutes.”

In another example relating to teacher support, the server generates the following prompt sentence:

“You are a generative AI model assisting a middle school math teacher. Based on the following curriculum excerpt, generate a 45-minute lesson plan on linear functions for 1 st-year students, including objectives, explanation flow, and a short quiz. The teacher is feeling time pressure, so structure the plan to minimize preparation time.”

In yet another example relating to guardian communication, the server generates the following prompt sentence:

“The user is a teacher feeling anxiety about explaining a student's declining grades to the parents. Using the following school policy and case data, generate a respectful, reassuring script and a checklist for a 30-minute parent meeting that addresses the parents' concerns and proposes concrete support measures.”

The server inputs the prompt sentence to the generative AI model by converting the prompt sentence into a sequence of tokens, mapping tokens to embeddings, and forwarding the embeddings through the neural network. The model computes attention scores and intermediate activations layer by layer, and outputs a sequence of tokens representing solution information. The server converts the tokens back to text and then parses this text into a higher-level data format such as a list of problems, a set of sections in a plan, or a set of recommended items with justifications.

The server converts the generated text into structured records by applying rule-based parsers and pattern-matching algorithms. For example, the server identifies question headers, numbering, answer markers, estimated time annotations, and section headings, and stores them in relational tables with fields for problem text, answer text, explanation text, estimated time, and difficulty level. The server links each structured piece of solution information to the originating prompt sentence and to the feature data used to construct that prompt.

The terminal acquires user input and sensor data. The user operates the terminal to enter text describing needs, such as “I want to finish my math homework efficiently,” “I need a new lesson plan for linear functions,” or “I am worried about how to talk to the parents.” The terminal sends text input to the server. Additionally, the terminal captures audio and video data using the microphone and camera. The terminal transmits this data to an emotion recognition device or to the server for analysis. In some embodiments, the terminal performs local pre-processing, such as down-sampling video, compressing audio, or extracting simple facial or acoustic features, to reduce transmission load.

The server implements an emotion recognition function using a separate machine learning model, such as a convolutional neural network for images or a recurrent neural network for audio. The server extracts features such as facial landmarks, voice pitch, energy, and text sentiment indicators, and classifies them into emotion labels using a softmax layer. The server assigns an intensity score for each emotion and stores the dominant emotion label and its intensity as emotion information. This processing uses non-conventional feature combinations tailored to learning and service contexts, such as combining difficulty of recent tasks, frequency of help requests, and facial tension indices.

The server evaluates the effectiveness of solution information by analyzing operation information and learning activity information from the terminal. The terminal records which parts of the generated plan or assignment set the user accessed, how long the user spent on each problem, how many problems the user answered correctly, and which explanations the user requested. The terminal sends this data to the server. The server computes evaluation results such as learning gain estimates, completion ratio, and user-reported satisfaction scores. The server links each evaluation result with the corresponding prompt sentence and the associated model output.

The server adapts prompt-sentence generation rules and model use conditions based on accumulated evaluation results. In one embodiment, the server maintains parameterized templates for prompt sentences, where weights are assigned to elements such as detailed task description, explicit difficulty bounds, and explicit emotion instructions. The server performs gradient-free optimization or gradient-based optimization over these template parameters, using evaluation results as an objective function. For example, the server increases the weight of explicit time constraints if content generated with clear time constraints shows higher completion rates, and the server reduces the length of context blocks if long prompts consistently produce slower responses or lower relevance.

The server further adjusts model use conditions such as sampling temperature, maximum token length, and model selection. The server records, for each interaction, which configuration produced the response and what evaluation result followed. The server then uses multi-armed bandit algorithms or reinforcement learning techniques to bias future choices towards configurations that historically produced higher effectiveness under similar feature data and emotion information. This causes the computing system to automatically learn which prompt structure and model parameters are technically optimal for given user states and contexts.

The server thereby improves computer technology by reducing the number of generative AI calls required to reach satisfactory outputs, shortening average response time, and lowering network and processor load. Because prompt sentences encode more precise task content and constraints derived from feature data, the generative AI model performs fewer unnecessary internal inferences, and the server rarely needs to re-query the model with corrective prompts. The structured representation of solution information allows the server to cache and reuse parts of outputs across sessions, which further saves computational resources. The adaptive optimization of prompt rules and model conditions leads to more accurate and stable outputs, thereby reducing variance in system behavior and simplifying downstream error handling. The server implements storage structures specifically optimized for linking information sets, feature data, prompt sentences, solution information, and evaluation results. For instance, the server uses a relational schema with foreign keys connecting a prompt table, a solution table, a feature table, and an evaluation table. The server uses indexes on user identifiers, classification items, and emotion labels to quickly retrieve relevant historical entries. This design differs from conventional unstructured logging by enabling efficient query patterns required for adaptive optimization and by reducing I/O overhead when searching for past cases similar to the current one.

The terminal presents solution information to the user in a form suitable for interaction. For a learning plan or assignment set, the terminal displays problems individually with input fields and optional “show explanation” controls. For a response plan or guardian communication script, the terminal displays sections with headers, bullet points, and editable text areas. The user can modify the text, re-order items, or add comments. The terminal transmits edited solution information back to the server, where it is stored alongside the original solution information. The difference between original and edited content is also recorded, which allows the server to identify which parts of the generative output consistently require editing and to adapt prompt templates accordingly.

In additional embodiments, the server applies the same architecture to non-educational domains. The server can classify medical, technical, or legal information as higher-level items and case-based items, compute feature data such as risk scores or complexity levels, and generate domain-specific prompt sentences for a generative AI model. The same feedback loop and adaptive optimization apply, leading to improved technical performance of computer-implemented generative systems in multiple application contexts.

The server thus coordinates multiple software modules and data structures to implement a non-conventional processing flow: the server does not simply pass user text to a generative AI model and display responses. Instead, the server builds and maintains a structured information base, computes feature data, generates prompt sentences with explicit technical encodings of task content, constraints, and emotion, converts outputs into structured formats, and closes a technical feedback loop that updates internal rules and model conditions. These actions result in measurable technical effects, such as improved processing speed, reduced error rate, more efficient storage and retrieval of generated artifacts, and lower communication load, and provide a concrete improvement to computer technology rather than a mere automation of human judgment.

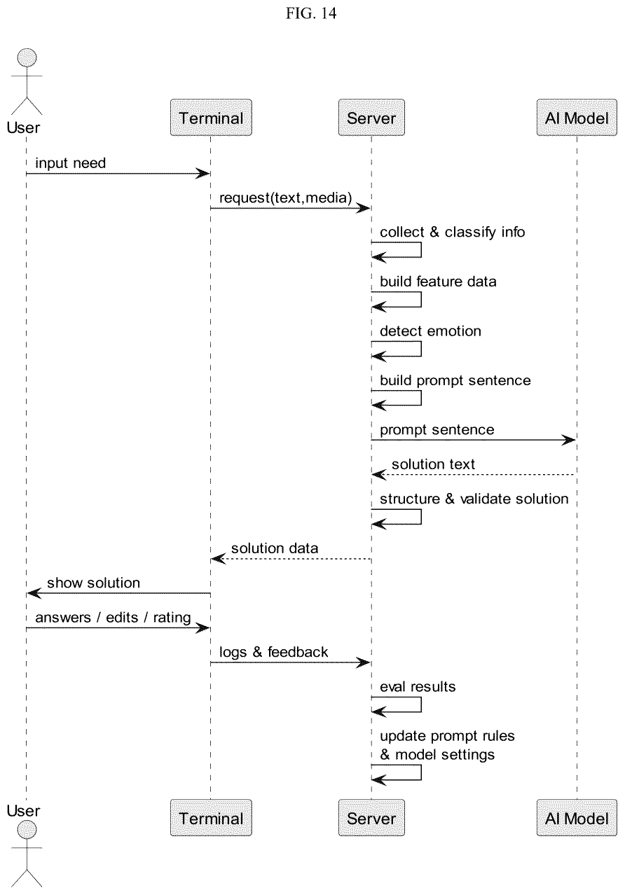

The following describes the processing flow using FIG. 14.

### Step 1:

Server prepares identification information and targets external sources.

Server receives, as input, configuration data specifying domains (for example, education), categories (for example, mathematics, language), and source addresses (for example, website URLs or API endpoints). Server parses this configuration and generates identification information items, each including at least a domain label, a category label, and a source address. Server outputs a list of identification information records that will be used to drive subsequent information acquisition.

### Step 2:

Server acquires raw information through a communication network.

Server takes, as input, the list of identification information records from Step 1. For each record, server sends HTTP or API requests via a network interface to external content servers. Server receives HTML, XML, JSON, or text responses as raw information. Server stores the raw documents temporarily in memory or a staging area. Server outputs a collection of raw information objects, each linked to the corresponding identification information.

### Step 3:

Server parses and normalizes acquired information.

Server uses, as input, the raw information objects obtained in Step 2. Server applies parsing routines: for HTML, server extracts title, body, headings, and metadata; for JSON, server extracts field values; for text, server applies tokenization. Server then performs basic normalization, such as character encoding conversion, whitespace cleanup, and date format standardization. Server outputs normalized text blocks and metadata structures that are suitable for language and classification processing.

### Step 4:

Server classifies information into higher-level and case-based categories.

Server uses, as input, the normalized text blocks and metadata from Step 3. Server runs classification algorithms, for example rule-based keyword matching and machine-learning classifiers, to assign higher-level classification items (such as subject, grade, topic) and case-based classification items (such as exam preparation, remedial learning, time-constrained case). Server performs data computation by converting each document into feature vectors (for example, term frequencies) and applying trained classification models to produce labels. Server outputs classification labels and attaches them to each text block, thereby forming classified information records.

### Step 5:

Server constructs a structured information set and stores it.

Server takes, as input, the classified information records from Step 4. Server maps each record into a predefined schema, for example a table with columns for source ID, higher-level classification item, case-based classification item, title, body text, key terms, and timestamps. Server writes these structured records into a storage device via a database management system. Server may also build indexes on classification fields for fast retrieval. Server outputs persistent identifiers and an updated structured information set table ready for later queries.

### Step 6:

Server associates user histories and computes feature data.

Server uses, as input, the structured information set from Step 5 and user-related logs stored in the database, including learning history information, work history information, performance information, and evaluation information. Server executes database queries to retrieve all records for a given user or group, then computes aggregations such as average scores per topic, frequency of errors by classification item, and moving averages over time. Server calculates feature data vectors that include values such as mastery level, speed, and stability for each classification item. Server outputs, for each user or case, a set of feature data records linked to classification items in the structured information set.

### Step 7:

Terminal collects user input and sensor data.

Terminal accepts, as input, direct interactions from the user. User types text describing needs (for example, “I want to finish my math homework efficiently”) or selects options in a graphical user interface. Terminal also captures sensor data such as audio from a microphone and images or video from a camera. Terminal optionally pre-processes audio into text using local or remote speech recognition and extracts basic media features (such as loudness or facial region crops). Terminal outputs a request packet containing user text, optional media features, and a user identifier, and sends this packet to the server.

### Step 8:

Server recognizes user emotion and encodes emotion information.

Server uses, as input, the user text and media features received from the terminal in Step 7. Server forwards these inputs to an emotion recognition function, which computes emotion probabilities based on text sentiment, acoustic cues, and facial indicators. Server performs data computation by applying a trained classifier to generate emotion scores (for example, stress 0.8, anxiety 0.7) and then selects the dominant emotion and its intensity as emotion information. Server outputs discrete emotion labels and intensity values associated with the user and the current request.

### Step 9:

Server selects relevant information and context for prompt construction.

Server takes, as input, the feature data from Step 6, the structured information set from Step 5, and the emotion information from Step 8. Server performs database queries to select a subset of records whose classification items match the user's current subject, level, and case type (for example, “grade 8, quadratic equations, exam preparation”). Server also selects past successful solutions and policies when available. Server computes a compact context set by limiting the number of records and extracting only key parts (for example, representative problems, high-level guidelines). Server outputs a context bundle consisting of feature data and selected structured information ready to be encoded into a prompt sentence.

### Step 10:

Server generates a prompt sentence for a generative AI model.

Server uses, as input, the context bundle from Step 9 and the current task type (for example, learning plan, assignment set, evaluation test, response plan, product proposal). Server executes template logic that inserts task content, constraint conditions (such as time limits and difficulty), and emotion information into natural-language templates. Server performs data concatenation and parameter substitution to produce a complete prompt sentence. Server outputs a prompt sentence string, such as:

“The user is a 2nd-year junior high school student who is weak in quadratic equations. The user is feeling stress and has only 30 minutes to study. Using the following topics and past scores, generate a set of 10 practice problems on quadratic equations for the user, with problems from basic to intermediate level and short step-by-step explanations that can be completed within 30 minutes.”

### Step 11:

Server submits the prompt sentence to the generative AI model and generates raw solution text.

Server uses, as input, the prompt sentence from Step 10. Server tokenizes the prompt sentence into tokens, maps tokens to numerical indices, and feeds the indices to a generative AI model (for example, a transformer-based language model) via an inference API. The model performs internal matrix multiplications and attention calculations to generate a sequence of output tokens. Server decodes the output tokens back into text, resulting in raw solution text such as problem lists, lesson plans, or scripts. Server outputs this raw solution text and associates it with the originating prompt sentence and context identifiers.

### Step 12:

Server converts raw solution text into structured solution information.

Server uses, as input, the raw solution text from Step 11. Server applies parsers and pattern-matching rules to detect structural elements, such as numbered problems, answers, explanations, sections, headings, and time annotations. Server then populates structured records, for example, a problem table with columns for statement, answer, explanation, estimated time, and difficulty, and a plan table with columns for section title, content, and order. Server outputs structured solution information objects, each representing a machine-readable and indexable representation of the generated content.

### Step 13:

Server evaluates basic constraints and quality of solution information.

Server uses, as input, the structured solution information from Step 12 and the constraint conditions encoded in the prompt sentence. Server executes validation checks, for example counting the number of generated problems, verifying that estimated times fit within the specified time limit, and ensuring that classification items (such as grade level) match the user profile. Server flags violations and may perform automatic adjustments, such as trimming excess problems or lowering difficulty labels. Server outputs validated and possibly adjusted solution information along with validation status flags.

### Step 14:

Server sends solution information to the terminal for presentation.

Server takes, as input, the validated structured solution information from Step 13. Server serializes the information into a transport format, for example structured messages containing sections, problem lists, and metadata. Server transmits these messages to the terminal over the network. Server outputs a response packet that includes content for display and interaction instructions (for example, which fields are editable and which are answer fields).

### Step 15:

Terminal presents solution information and collects user interaction logs.

Terminal uses, as input, the response packet from Step 14. Terminal renders user interface components, such as problem lists with input fields, buttons to reveal explanations, and editable text areas for plans or scripts. User interacts with these components by typing answers, clicking buttons, or editing text. Terminal records interaction events, including timestamps, selected items, correctness indicators (when answers are checked), and user edits to generated text. Terminal outputs a log dataset describing the user's behavior while using the solution information.

### Step 16:

User performs learning, teaching, or service actions.

User uses, as input, the displayed solution information on the terminal. User solves problems, follows a learning plan, or uses a script in a meeting or customer interaction. User may also rate usefulness, indicate satisfaction, or mark sections as not applicable. User's choices and performance outcomes constitute implicit and explicit feedback. User thereby produces, as output, behavior and response data that the terminal can record and later send to the server for further processing.

### Step 17:

Terminal transmits logs, performance results, and feedback to the server.

Terminal uses, as input, the interaction logs and any explicit feedback from Step 15 and Step 16. Terminal aggregates these records per session or per content item, compresses and formats them into a report message containing event types, times, correctness, completion ratios, and user ratings. Terminal transmits this report to the server via the network interface. Terminal outputs structured log and feedback data that describe the real usage of the solution information.

### Step 18:

Server computes evaluation results from logs and feedback.

Server takes, as input, the log and feedback data from Step 17 and the structured solution information from Step 12 or Step 13. Server correlates events with specific problems, sections, and prompt sentences by matching identifiers. Server performs data computation to derive evaluation metrics such as percentage completed, average correctness, average time per item, and user satisfaction scores. Server also analyzes which parts of the content were edited frequently by the user. Server outputs evaluation results, including numerical scores and qualitative indicators, and stores them together with references to the prompt sentence and the generative AI model output.

### Step 19:

Server updates prompt-sentence generation rules and model use conditions.

Server uses, as input, the evaluation results from Step 18 and the stored history of prompt templates and model configurations. Server runs optimization logic that compares performance across different prompt structures and model parameters under similar feature data and emotion information. Server computes adjustment values for template parameters (for example, how explicitly to state constraints) and for model parameters such as sampling temperature. Server then updates internal rule tables and configuration files to bias future prompt generation and model invocation towards combinations that showed superior evaluation scores. Server outputs updated prompt-generation rules and updated model use conditions for subsequent requests.

### Step 20:

Server stores and manages edited solution information for reuse.

Server takes, as input, the edited solution information that the terminal transmitted in Step 17 (if the user edited generated content). Server stores original and edited versions in the storage device, linking them to prompt sentences, feature data, and evaluation results. Server performs data analysis to detect systematic editing patterns (for example, recurring rewrites of instructions or frequent additions of clarifying phrases). Server uses these patterns to refine templates and feature mappings. Server outputs an updated repository of solution information that can be partially reused or referenced for future requests, reducing future computational load and improving quality of newly generated solution information.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

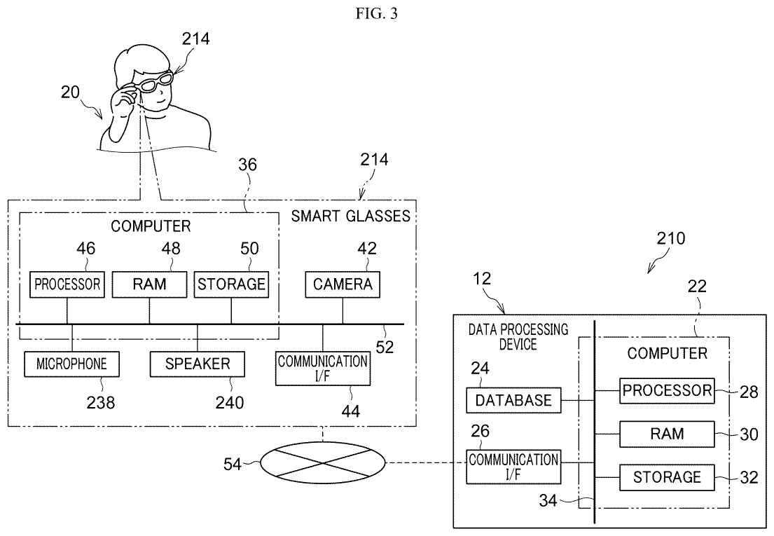

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

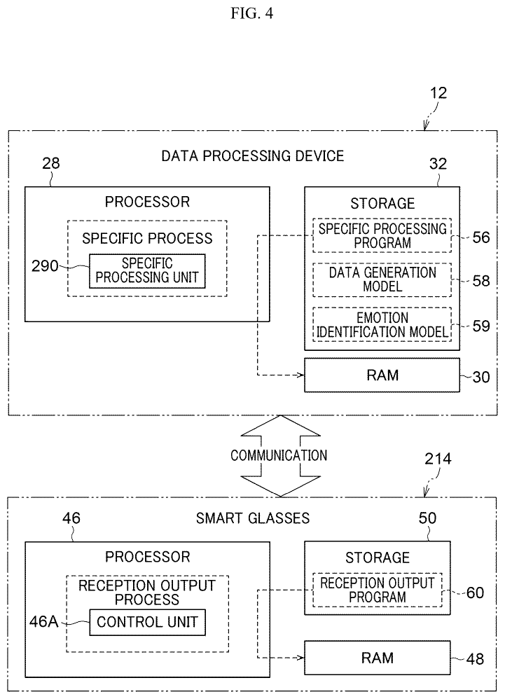

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

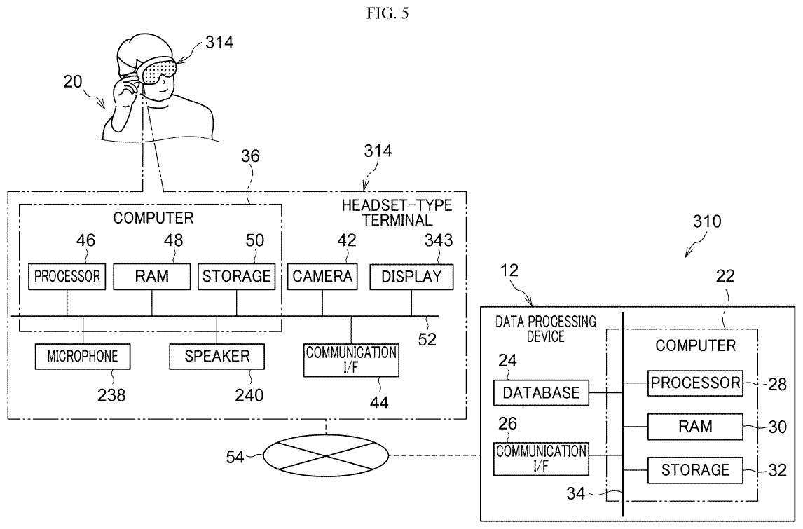

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

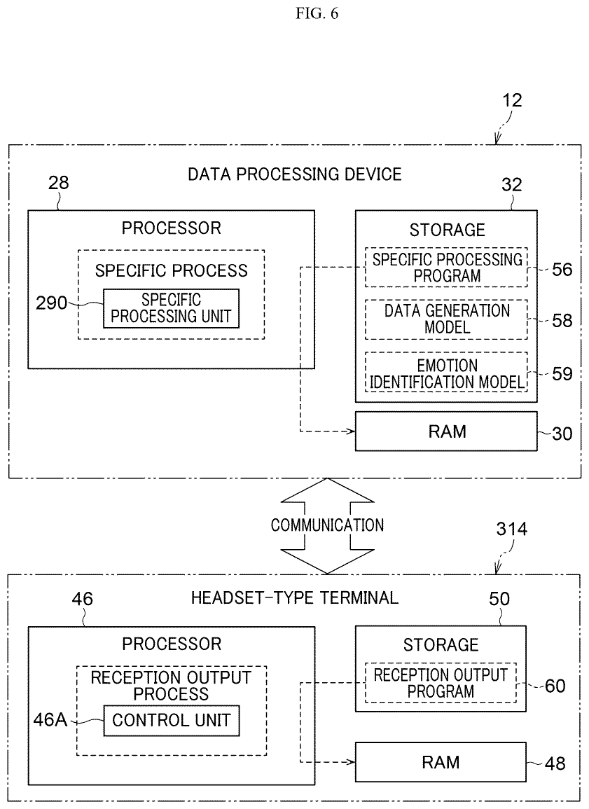

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

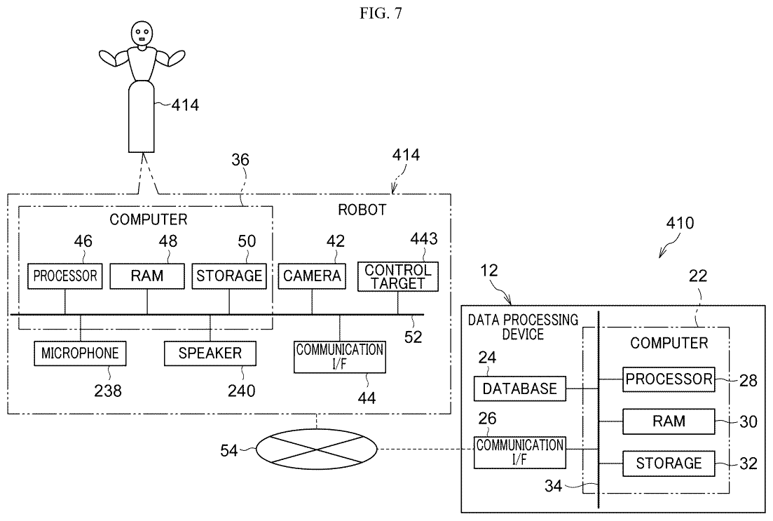

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

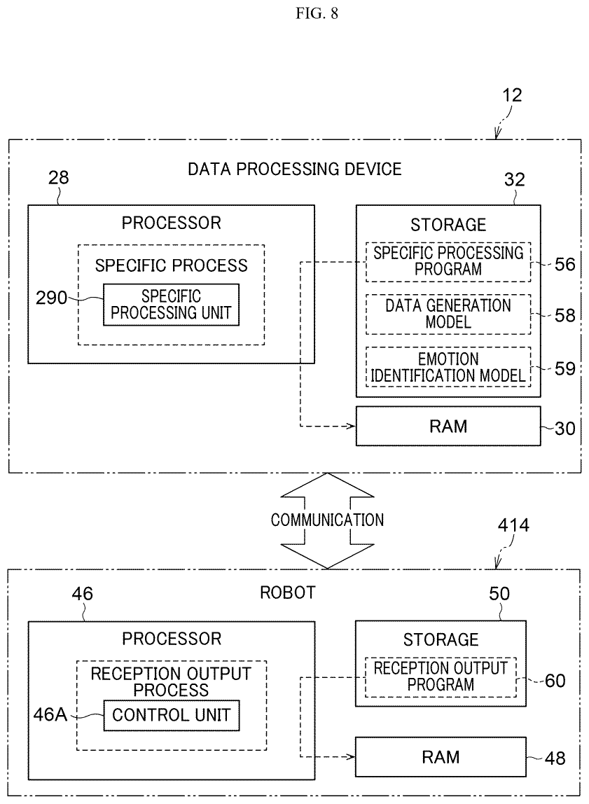

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

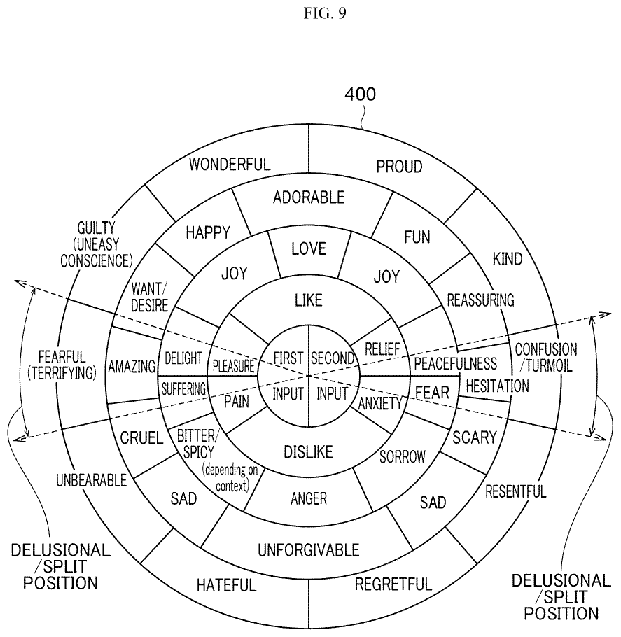

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

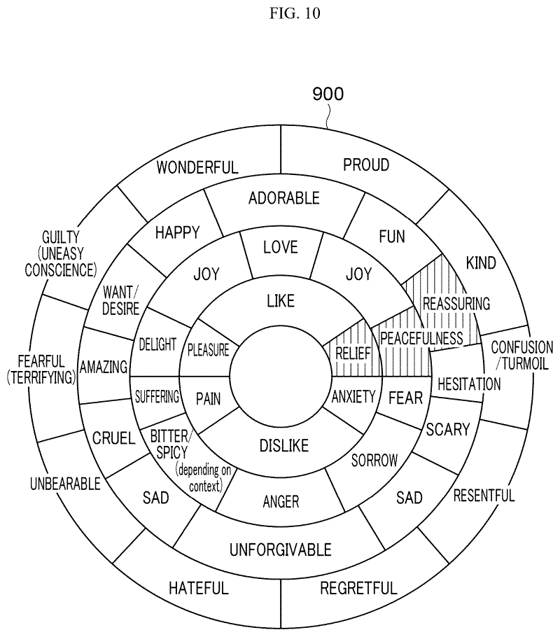

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
generate identification information for information-collection targets and, based on the identification information, create a list of information-collection targets including location information of education-related information sources,
obtain, by using the location information included in the list of information-collection targets, education-related document information from an external information processing apparatus via a communication network, and record the obtained document information as unstructured electronic documents,
analyze the obtained electronic documents by using an analysis program, remove display-related structure information, extract education-related body text, and generate analysis-target text data by performing preprocessing including character-string normalization and morphological analysis or word segmentation,
apply, to the analysis-target text data, topic estimation and relevance calculation by using vocabulary information related to an education field or a learning model, and generate education-related information records classified for each education category including at least a learning-task-creation category, an evaluation-test-creation category, and a guardian-correspondence category,
register the education-related information records, as structured data including category information, summary information, location information, and search index information, in a data storage apparatus including a relational data management apparatus or a similar data storage apparatus, and generate data structures for full-text search indexes or vector search indexes,
receive, from a user terminal, a prompt sentence related to an educational task, preprocess the prompt sentence by natural language processing, execute full-text search and semantic-similarity search on the data storage apparatus, extract education-related information records related to the prompt sentence, and generate context information by summarizing or formatting extraction results,
generate input data including the prompt sentence and the context information, format the input data as model input data to be input to a generative AI model, and operate the generative AI model to generate an education-related solution in accordance with an individual request,
and perform content checking or format adjustment on the solution output from the generative AI model, generate presentation data for providing the solution to the user terminal, and transmit the presentation data to the user terminal via the communication network.

### (Supplementary 2)

The system according to supplementary 1,
wherein the processor is configured to, when the prompt sentence received from the user terminal includes a request related to learning-task creation or evaluation-test creation, extract, with priority, from the data storage apparatus, education-related information records related to learning-task creation or evaluation-test creation on the basis of an analysis result of the prompt sentence, and provide the extracted education-related information records as the context information to the generative AI model so as to cause the generative AI model to generate a solution related to learning-task creation or evaluation-test creation.

### (Supplementary 3)

The system according to supplementary 1,
wherein the processor is configured to, when the prompt sentence received from the user terminal includes a request related to guardian correspondence, extract, with priority, from the data storage apparatus, education-related information records related to communication cases with guardians or requests of guardians on the basis of an analysis result of the prompt sentence, and provide the extracted education-related information records as the context information to the generative AI model so as to cause the generative AI model to generate a solution including a correspondence measure in accordance with a need of a guardian.

### Application Example 1

### (Supplementary 1)

A system comprising a processor and a memory storing instructions,
wherein the processor is configured to execute the instructions to prepare identification information of information sources connected via a communication network, and acquire unstructured information data including educational-related information from the information sources via the communication network based on the identification information;
analyze a structure of the acquired information data, extract the educational-related information from character information and associated information by performing character-string processing or natural-language processing on the information data, and generate classification information by assigning category information and case information to the educational-related information;
store the classification information, as records including an item identifier, source information, the category information, and the case information, in a relational data management device, and accumulate the classification information as a searchable educational-related information set;
execute a query process on the relational data management device based on search conditions including character-string information or the category information and the case information received from a user terminal, extract related information corresponding to the search conditions from the educational-related information set, and provide the related information to the user terminal;
generate context information by summarizing or extracting the related information obtained from the relational data management device, generate instruction-sentence data as a prompt sentence including the context information and request information received from the user terminal as an individual request, and output the instruction-sentence data;
input the prompt sentence to a generative artificial intelligence model, and obtain generated output as solution information corresponding to the context information and the request information from the generative artificial intelligence model;
convert the obtained solution information into presentation-format data that a user is able to view or output, and provide the presentation-format data via the user terminal; and
store the prompt sentence and the solution information as history information in the relational data management device or in a separate storage device, and make the history information available for use in a subsequent search process or solution-generation process.

### (Supplementary 2)

The system according to supplementary 1,
wherein the processor is configured to analyze a prompt sentence including request information relating to creation of learning tasks or evaluation tasks, select related information including learning-content information and evaluation-criterion information from the educational-related information set, and generate solution information including a configuration plan of the learning tasks or the evaluation tasks by using the related information.

### (Supplementary 3)

The system according to supplementary 1,
wherein the processor is configured to analyze a prompt sentence including request information relating to responses to guardians, select related information including guardian-characteristic information and educational-policy information from the educational-related information set, and generate solution information including a response-policy plan or a communication plan corresponding to requests of the guardians based on the related information.

### Example 2

### (Supplementary 1)

A system comprising a processor and a storage device,
wherein the processor is configured to receive, from a terminal, a user request and extract learning condition information or response condition information included in the user request,
acquire, based on the learning condition information or the response condition information, educational information and past case information from a communication network and the storage device, classify the acquired information by case type and difficulty type, organize the acquired information on a case basis, and store the organized information in the storage device,
generate, using the information stored in the storage device, a prompt sentence including grade information, subject information, learning theme information or response theme information, and embedding curriculum summary information and representative case information in a predetermined structure, and instruct a generative AI model to receive the prompt sentence as input,
analyze solution information output from the generative AI model, extract problem statement information, answer information, and explanation information or response plan information from the solution information, generate structured data including the extracted information, and store the structured data in the storage device, and
transmit solution information based on the structured data to the terminal and provide the solution information in a form displayable or outputtable by the terminal.

### (Supplementary 2)

The system according to supplementary 1,
wherein the processor is configured to
extract grade information, subject information, and learning theme information from the user request, acquire teaching material information and past case information stored in the storage device in association with the grade information and the subject information, embed curriculum summary information and representative example information including the teaching material information and the past case information into the prompt sentence, and
cause the generative AI model to generate solution information relating to creation of learning tasks and creation of evaluation tests.

### (Supplementary 3)

The system according to supplementary 1,
wherein the processor is configured to
extract target attribute information and consultation theme information from the user request, acquire guardian response case information and communication guideline information stored in the storage device in association with the target attribute information and the consultation theme information, embed the guardian response case information and the communication guideline information into the prompt sentence, and cause the generative AI model to generate response measure information relating to guardian response.

### Application Example 2

### (Supplementary 1)

A system comprising a processor,
wherein the processor is configured to
prepare identification information indicating an information collection target,
acquire information including education-related information through a communication network on the basis of the identification information,
analyze the acquired information and classify the acquired information according to higher-level classification items and case-based classification items to generate a structured information set,
store the structured information set in a storage device, and associate learning history information or work history information and performance information or evaluation information with the information set stored in the storage device to calculate feature data,
generate, on the basis of the feature data and the higher-level classification items and the case-based classification items included in the information set, a prompt sentence including task content, constraint conditions, and emotion information for input to a generative AI model, and issue an instruction to input the prompt sentence to the generative AI model,
obtain, from the generative AI model, solution information including at least one of a learning plan, an assignment set, an evaluation test plan, a response plan, and a product proposal generated in response to the prompt sentence, and convert the solution information into a higher-level data format and store the converted solution information in the storage device,
evaluate effectiveness of the solution information on the basis of at least one of operation information, learning activity information, and service use information acquired from a terminal device and emotion information acquired from an emotion recognition device or an emotion recognition function, and store an evaluation result in association with the information set and the prompt sentence,
update a prompt-sentence generation rule or a model use condition on the basis of a relationship among the stored evaluation result, the prompt sentence, and an output of the generative AI model, and adaptively optimize a subsequently generated prompt sentence and subsequently generated solution information, and
provide the solution information to a user via the terminal device and acquire edited solution information from the user and store the edited solution information again.

### (Supplementary 2)

The system according to supplementary 1,
wherein the processor is configured to
construct, as the prompt sentence, a sentence that instructs the generative AI model to generate solution information relating to creation of learning assignments and creation of evaluation tests, on the basis of at least a higher-level classification item of a learning target, a learning ability indicator, a time constraint, and emotion information of the user, and
provide, as the solution information obtained from the generative AI model, learning assignments, evaluation test plans, and explanation information, as structured data including difficulty information and required-time information, to the terminal device.

### (Supplementary 3)

The system according to supplementary 1,
wherein the processor is configured to
construct, as the prompt sentence, a sentence that instructs the generative AI model to generate solution information relating to guardian support including at least a meeting plan, an explanatory draft, and an action guideline, on the basis of at least guidance-policy information in an educational organization, guardian attribute information, and emotion information of the user, and convert the solution information obtained from the generative AI model into a format suitable for display and editing on the terminal device and provide the converted solution information.

What is claimed is:

1. A system comprising:
circuitry configured to:
receive, via a communication interface coupled to a packet-switched network, identification information indicating one or more information-collection targets;
obtain, via the communication interface, document information from an external information processing apparatus based on the identification information, and store the document information as unstructured electronic documents in a storage device;
analyze the unstructured electronic documents using an analysis program, remove structure information unrelated to substantive content, extract body text, and generate analysis-target text data by performing preprocessing including character-string normalization and morphological analysis;
apply topic estimation and relevance calculation to the analysis-target text data using vocabulary information or a learning model, and generate classified information records assigned to one or more information categories;
register the classified information records, including category information, summary information, and search index information, in the storage device, and generate data structures for full-text search indexes or vector search indexes in the storage device;
receive, via the communication interface, a prompt sentence from a terminal device, execute full-text search and semantic-similarity search on the storage device using the prompt sentence, and generate context information from extracted classified information records; and
generate model input data including the prompt sentence and the context information, operate a generative neural network model using the model input data to generate a solution in response to an individual request, and transmit the solution to the terminal device via the communication interface.

2. The system according to claim 1, wherein the circuitry is configured to perform the preprocessing by executing a markup parser on the unstructured electronic documents, constructing a node tree representation, and applying heuristic filters that distinguish substantive body text from navigation elements and display-related markup based on text-density metrics.

3. The system according to claim 2, wherein the circuitry is configured to perform character-string normalization by converting character encodings to a standard format, normalizing whitespace and punctuation, and performing morphological analysis or word segmentation using a pre-trained tokenization model.

4. The system according to claim 3, wherein the circuitry is configured to apply topic estimation by computing term-frequency inverse-document-frequency vectors for text segments, inputting the vectors to a classifier model, and computing probability scores for each information category using matrix multiplications and nonlinear activation functions.

5. The system according to claim 4, wherein the circuitry is configured to generate data structures for vector search indexes by computing dense vector embeddings for each classified information record using a sentence-level encoder, and storing the embeddings in an approximate nearest-neighbor index structure.

6. The system according to claim 1, wherein the circuitry is configured to generate the context information by executing a hybrid retrieval procedure that merges results of the full-text search and the semantic-similarity search using a combined score computed from keyword relevance, semantic similarity, category match, and record recency, and selecting top-ranked records.

7. The system according to claim 6, wherein the circuitry is configured to construct the context information by applying an extractive summarization algorithm that selects representative sentences from the top-ranked records based on sentence centrality in an embedding space, assembling the sentences into a structured context document, and truncating the context document to a token budget.

8. The system according to claim 7, wherein the circuitry is configured to generate the model input data by organizing the prompt sentence and the context information into sections including an instruction portion, a user query portion, and a retrieved context portion, and arranging the sections so that the most relevant context appears proximate to the prompt sentence.

9. The system according to claim 1, wherein the circuitry is configured to receive, from the terminal device, request information specifying a learning-task-creation request or an evaluation-test-creation request, extract, with priority, classified information records associated with a learning-task-creation category or an evaluation-test-creation category from the storage device based on an analysis result of the prompt sentence, and cause the generative neural network model to generate a solution including a learning assignment set or an evaluation test plan.

10. The system according to claim 9, wherein the circuitry is configured to extract grade information and learning theme information from the request information, acquire curriculum information and past case information stored in the storage device in association with the grade information and the learning theme information, and embed curriculum summary information and representative case information derived from the curriculum information and the past case information into the model input data.

11. The system according to claim 10, wherein the circuitry is configured to classify retrieved information by case type and difficulty type, organize the retrieved information on a case basis in the storage device, and generate a prompt sentence that includes grade information, subject information, learning theme information, and the curriculum summary information embedded in a predetermined structure.

12. The system according to claim 1, wherein the circuitry is configured to receive, from the terminal device, request information including a response-to-guardian request, extract classified information records associated with a guardian-correspondence category from the storage device, and cause the generative neural network model to generate a solution including a response measure corresponding to a need expressed in the request information.

13. The system according to claim 12, wherein the circuitry is configured to extract target attribute information and consultation theme information from the request information, retrieve guardian-response case information and communication guideline information from the storage device in association with the target attribute information and the consultation theme information, and embed the guardian-response case information and the communication guideline information into the model input data.

14. The system according to claim 1, wherein the circuitry is configured to store the prompt sentence and the solution as history information in the storage device, and, upon receiving a subsequent prompt sentence, query the history information prior to or in parallel with querying the classified information records to detect similarity between the subsequent prompt sentence and a previous prompt sentence using vector-space similarity on prompt embeddings, and reuse or adapt a previously generated solution when similarity exceeds a threshold.

15. The system according to claim 14, wherein the circuitry is configured to evaluate effectiveness of the solution based on operation information and learning activity information received from the terminal device, store an evaluation result in association with the history information and the prompt sentence, and update a prompt-sentence generation rule or a model use condition based on a relationship among the evaluation result, the prompt sentence, and an output of the generative neural network model to adaptively optimize subsequently generated prompt sentences.

16. The system according to claim 1, wherein the circuitry is configured to receive emotion information estimated by an emotion recognition function from sensor data acquired by the terminal device, and encode the emotion information as an explicit instruction in the model input data specifying an adjustment to tone or structure of the solution generated by the generative neural network model.

17. The system according to claim 16, wherein the circuitry is configured to construct a feature data vector by associating learning history information or work history information and performance information with the classified information records, and generate the model input data including task content, constraint conditions, and the emotion information based on the feature data vector and classification items of the classified information records.

18. A system comprising:
circuitry configured to:
obtain, via a communication interface coupled to a packet-switched network, education-related document information from external information processing apparatuses based on identification information of information-collection targets, and store the document information as unstructured electronic documents in a storage device;
execute an analysis program on the unstructured electronic documents to remove display-related structure information, extract body text, and generate analysis-target text data by performing character-string normalization and morphological analysis or word segmentation;
compute feature vectors for the analysis-target text data by computing term-frequency inverse-document-frequency values or dense embeddings using a pre-trained encoder, apply a trained classifier to assign education category labels including a learning-task-creation category, an evaluation-test-creation category, and a guardian-correspondence category and associated relevance scores, and register resulting classified information records including category information, summary information, and search index information in the storage device;
generate full-text search indexes and vector search indexes for the classified information records in the storage device;
receive a prompt sentence from a terminal device via the communication interface, compute query feature vectors for the prompt sentence using the same feature extraction pipeline, execute hybrid full-text search and vector similarity search on the storage device to retrieve top-ranked classified information records, and generate context information by extractive summarization of the top-ranked records under a token budget;
construct model input data including the prompt sentence and the context information, and operate a generative neural network model using the model input data to generate a solution; and
perform content checking and format adjustment on the solution, and transmit presentation data including the solution to the terminal device via the communication interface.

19. The system according to claim 18, wherein the circuitry is configured to store the prompt sentence and the solution as history information in the storage device, detect similarity between a subsequent prompt sentence and a previous prompt sentence using prompt embeddings, and reuse or adapt a previously generated solution to reduce generative neural network model inference load when similarity exceeds a threshold.

20. A method comprising:
receiving, via a communication interface coupled to a packet-switched network, identification information indicating one or more information-collection targets;
obtaining, via the communication interface, document information from an external information processing apparatus based on the identification information, and storing the document information as unstructured electronic documents in a storage device;
analyzing the unstructured electronic documents using an analysis program,
removing structure information unrelated to substantive content, extracting body text, and generating analysis-target text data by performing preprocessing including character-string normalization and morphological analysis;
applying topic estimation and relevance calculation to the analysis-target text data using vocabulary information or a learning model, and generating classified information records assigned to one or more information categories;
registering the classified information records, including category information, summary information, and search index information, in the storage device, and generating data structures for full-text search indexes or vector search indexes;
receiving, via the communication interface, a prompt sentence from a terminal device, executing full-text search and semantic-similarity search on the storage device using the prompt sentence, and generating context information from extracted classified information records; and
generating model input data including the prompt sentence and the context information, operating a generative neural network model using the model input data to generate a solution in response to an individual request, and transmitting the solution to the terminal device via the communication interface.
